(19) United States
(12) Patent Application Publication
(10) Pub. No.: US 2025/0339822 A1
(43) Pub. Date: Nov. 6, 2025

(54) MEMBRANES WITH FUNCTIONALIZED PARTICLES CONTAINING METAL-ORGANIC FRAMEWORKS

(71) Applicant: MASSACHUSETTS INSTITUTE OF TECHNOLOGY, Cambridge, MA (US)

(72) Inventors: Zachary Smith, Belmont, MA (US); Gang Han, Tianjin (CN)

(73) Assignee: MASSACHUSETTS INSTITUTE OF TECHNOLOGY, Cambridge, MA (US)

(21) Appl. No.: 18/866,054

(22) PCT Filed: May 12, 2023
(86) PCT No.: PCT/US2023/021969

§ 371 Date: Nov. 14, 2024

Related U.S. Application Data
(60) Provisional application No. 63/342,122, filed on May 15, 2022.

(51) Int. Cl. B01D 69/14; B01D 67/00; B01D 69/02; B01D 71/56; B01D 71/70

(52) U.S. Cl. CPC B01D 69/14111; B01D 67/00793; B01D 69/02; B01D 69/148; B01D 71/56; B01D 71/70; B01D 2323/30; B01D 2325/04; B01D 2325/36

(57) ABSTRACT

Membranes and related systems and methods for separation of components in liquids are generally described. The membrane may include particles in a polymer matrix (e.g., a polyamide layer). The particles may include metal-organic framework particles comprising functional groups (e.g., from post-synthetic modification) that can, in some instances, improve the rejection and/or selectivity of the membrane. For example, the metal-organic framework may comprise functional groups bound to hydrophobic groups (e.g., alkyl chains) that assist with suspension stability in nonpolar solvents during membrane fabrication. As another example, the metal-organic framework may comprise functional groups bound to crosslinking agents that facilitate in situ crosslinking of the particles with the polymer matrix, thereby reducing voids in the membrane and/or leaching. In some instances, the membrane is a thin-film nanocomposite membrane (e.g., for separating components like charged species and/or neutral species) formed via, for example, interfacial polymerization in the presence of the particles.

### RELATED APPLICATIONS

This application claims priority under 35 U.S.C. § 119 (e) to U.S. Provisional Patent Application No. 63/342,122, filed May 15, 2022, and entitled “Thin-Film Nanocomposite Membranes for Separating Ions and Uncharged Species in Water,” which is incorporated herein by reference in its entirety for all purposes.

### TECHNICAL FIELD

Membranes and related systems and methods for separation of components in liquids are generally described.

### BACKGROUND

The rapid increase in global demand of fresh water for agriculture, livestock, and energy applications has stimulated substantial research for water treatment and purification technologies. Owing to the high separation efficiency, low energy requirement, small capital investment, and environmentally benign characteristics, membrane-based separations are playing an increasingly important role in addressing worldwide stress on existing fresh water sources. For instance, it is possible to reduce 90% of the energy required by thermal distillation by using reverse osmosis (RO) for seawater desalination. As a result, RO has been extensively used for desalination and water purifications, producing nearly 65.5 million m³ of water per day, which accounts for a 69% share of the global desalination capacity.

Polyamide thin-film composite (PA TFC) membranes generally have two layers; a porous substrate layer (usually made of polysulfone) and a thin PA layer (<200 nm) formed on it. The PA layer governs permeation properties of the membrane, while the sub-layer, which is porous, provides mechanical strength and support. The advantage of having the two layers made of different chemicals is that each layer can be individually synthesized or customized so as to optimize the overall performance of the membrane.

PA TFC membranes synthesized by an interfacial polymerization reaction between an aqueous diamine and an organic acid chloride solution on porous membrane supports currently dominate the desalination membrane market due to their higher salt rejection and water flux compared to other materials such as cellulosic membranes.

Unfortunately, polyamide TFC membranes fail to provide adequate rejections to small neutral contaminants such as boric acid because of their small molecule size and uncharged chemical structures under normal operating conditions. Additional treatments must be applied to purify the produced water, which increases energy consumption, capital costs, and chemical waste.

Accordingly, improved membranes (e.g., for separation of components in liquids) are desirable.

### SUMMARY

Membranes and related systems and methods for separation of components in liquids are generally described. The membrane may include particles in a polymer matrix (e.g., a polyamide layer). The particles may include metal-organic framework particles comprising functional groups (e.g., from post-synthetic modification) that can, in some instances, improve the rejection and/or selectivity of the membrane. For example, the metal-organic framework may comprise functional groups bound to hydrophobic groups (e.g., alkyl chains) that assist with suspension stability in nonpolar solvents during membrane fabrication. As another example, the metal-organic framework may comprise functional groups bound to crosslinking agents that facilitate in situ crosslinking of the particles with the polymer matrix, thereby reducing voids in the membrane and/or leaching. In some instances, the membrane is a thin-film nanocomposite membrane (e.g., for separating components like charged species and/or neutral species) formed via, for example, interfacial polymerization in the presence of the particles. The subject matter of the present invention involves, in some cases, interrelated products, alternative solutions to a particular problem, and/or a plurality of different uses of one or more systems and/or articles.

In one aspect, membranes are provided. In some embodiments, the membrane comprises: a polymer matrix; and particles, at least some of which reside within the polymer matrix, the particles comprising a metal-organic framework comprising functional groups, wherein: a first plurality of the functional groups are bonded to a hydrophobic species; and a second plurality of the functional groups are bonded to a crosslinking agent bound to the polymer matrix.

In another aspect, methods of forming at least a portion of a membrane are provided. In some embodiments, the method comprises: providing particles comprising a metal-organic framework in a solution comprising a crosslinking agent, wherein the metal-organic framework comprises functional groups; and exposing the particles and the crosslinking agent from the solution to a polymer or a monomer thereof such that at least some of the particles become crosslinked to a matrix of the polymer via a reaction between (a) a crosslinking agent that is or becomes bonded to a plurality of the functional groups and (b) the polymer or a monomer thereof.

One aspect of the disclosure herein is a thin film nanocomposite membrane comprising amine-functionalized metal organic framework (MOF) nanoparticles attached to a polyamide thin-film composite (TFC) membrane.

In one embodiment of the thin film nanocomposite membrane disclosed herein, the amine-functionalized MOF nanoparticles have a size of less than 40 nm in diameter.

In one embodiment of the thin film nanocomposite membrane disclosed herein, the amine-functionalized MOF nanoparticles comprise amine-functionalized MIL-101 (Cr)—NH₂ MOF nanoparticles.

In one embodiment of the thin film nanocomposite membrane disclosed herein, the amine-functionalized MOF nanoparticles comprise polyamide-functionalized MOF nanoparticles.

In one embodiment of the thin film nanocomposite membrane disclosed herein, the amine-functionalized MOF nanoparticles are attached to the TFC membrane by in situ crosslinking.

In one embodiment of the thin film nanocomposite membrane disclosed herein, the amine-functionalized MOF nanoparticles are modified by trimesoyl chloride (TMC), (3-glycidyloxypropyl)triethoxysilane (GPTES), or a combination thereof.

In one embodiment of the thin film nanocomposite membrane disclosed herein, the thin film nanocomposite membrane comprises TMC-modified MOF nanoparticles. In one embodiment, the thin film nanocomposite membrane has pore sizes of ˜6.5 Å and ˜25 Å.

In one embodiment of the thin film nanocomposite membrane disclosed herein, the thin film nanocomposite membrane comprises GPTES-modified nanoparticles. In one embodiment, the thin film nanocomposite membrane has pore sizes of ˜6 Å and ˜23 Å.

In one embodiment of the thin film nanocomposite membrane disclosed herein, the thin film nanocomposite membrane has a higher O/N atomic ratio and a greater degree of polyamide crosslinking than the polyamide TFC membrane.

In one embodiment of the thin film nanocomposite membrane disclosed herein, the thin film nanocomposite membrane has a higher hydrophilicity than the polyamide TFC membrane.

In one embodiment of the thin film nanocomposite membrane disclosed herein, rejection of NaCl is 95.0% or greater.

In one embodiment of the thin film nanocomposite membrane disclosed herein, rejection of MgCl₂, MgSO₄, and Na₂SO₄ is 98% or greater.

In one embodiment of the thin film nanocomposite membrane disclosed herein, water flux is 1.8 L m⁻² h⁻¹ or greater at 150 psi. In one embodiment, the water flux is 5.6-6.0 L m⁻² h⁻¹ at 150 psi.

In one embodiment of the thin film nanocomposite membrane disclosed herein, the MOF nanoparticles are modified by a combination of TMC and GPTES. In one embodiment, NaCl rejection is 98.5% with a water permeance of 0.9 L m⁻² h⁻¹ bar⁻¹ at 150 psi. In one embodiment, the NaCl rejection is 96.1% with a water permeance of 1.3 L m⁻² h⁻¹ bar⁻¹ at 150 psi. In one embodiment, rejection of MgCl₂, MgSO₄, and Na₂SO₄ is 99% or greater with a water permeance of greater than 8.0 L m⁻² h⁻¹ at 150 psi.

In one embodiment of the thin film nanocomposite membrane disclosed herein, rejection of PEG200 is 99.2% or greater at 150 psi.

In one embodiment of the thin film nanocomposite membrane disclosed herein, rejection of boric acid is 89% or greater at a pH value of 7.5 at 150 psi.

One aspect of the disclosure is a system for water purification comprising a filtration unit comprising the thin film nanocomposite membrane disclosed herein, wherein the filtration unit has a retentate side and a permeate side, each with an inlet and an outlet; wherein a liquid feed comprising an aqueous solution comprising a solute is pumped into the retentate side; wherein liquid at the outlet of the permeate side has a solute concentration that is substantially less than the liquid feed of the system.

In one embodiment of the system for water purification disclosed herein, the thin film nanocomposite membrane is spiral wound or hollow fiber.

One aspect of the disclosure is a method of filtering water using the system for water purification disclosed herein.

One aspect of the disclosure is a method of concentrating brine using the system for water purification disclosed herein.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a cross-sectional schematic diagram of an example of a membrane comprising a polymer matrix and particles, according to some embodiments.

FIG. 1B is a cross-sectional schematic diagram of an example of a membrane comprising a layer comprising a polymer matrix, particles, and a porous support layer, according to some embodiments.

FIG. 2A is a cross-sectional schematic diagram of an example of a particle comprising a MOF, functional groups, hydrophobic groups, and crosslinking agents, according to some embodiments.

FIG. 2B is a schematic diagram of a system comprising a filtration unit, according to some embodiments.

FIGS. 3A-3B are (3A) synthesis of MIL-101 (Cr)—NH₂ MOF nanoparticles and the zeolite-type framework representation of the MIL-101 structure showing the topological connectivity of the centers of a vertex-sharing supertetrahedra, and (3B) building blocks for MIL-101 (Cr)—NH₂. Trinuclear {Cr₃O} building units and bridging 2-aminoterephthalic acid ligands form pentagonal and hexagonal rings, which are assembled into mesoporous cages, according to some embodiments.

FIGS. 4A-4C are (4A) synthesis of the polyamide selective thin film via interfacial polymerization between TMC and MPD, (4B) TMC modification on MIL-101 (Cr)—NH₂, and (4C) the formation of MIL-101 (Cr)—NH₂-polyamide mixed matrix via in situ crosslinking, according to some embodiments.

FIG. 5 is TMC functionalization and the resulting pore dimensions and chemistry of TMC@MIL-101 (Cr)—NH₂ nanoparticles.

FIG. 6A shows SEM images of the polyethersulfone (PES) membrane substrate and the TFN membranes prepared with different TMC@MIL-101 (Cr)—NH₂ particle contents in hexane suspension, according to some embodiments. The Dow SW30XLE TFC membrane was used as a commercial benchmark for comparison.

FIG. 6B are SEM images of the TFN membranes prepared with different TMC@MIL-101 (Cr)—NH₂ particle loadings under higher magnifications, according to some embodiments.

FIG. 6C shows water contact angles for TFN membranes prepared with different TMC@MIL-101 (Cr)—NH₂ contents, according to some embodiments. TFN membranes with MIL-101 (Cr) particles were prepared under the same conditions for comparison.

FIGS. 7A-7D are (7A) pure water permeance (A, L m⁻² h⁻¹ bar⁻¹), (7B) NaCl rejection (R, %) tested at 50, 100, and 150 psi, and (7C) water/NaCl selectivity (A/B, bar⁻¹) at 150 psi for TFN membranes prepared with different TMC@MIL-101 (Cr)—NH₂ particle contents in hexane suspension, according to some embodiments. (7D) Water flux and rejection for the TFN (0.04) membrane using different inorganic salts as the solutes at 150 psi, according to some embodiments. Water permeance tests were performed using deionized water as the feed, while 2000 ppm salt solutions were used for rejection tests. The Dow SW30XLE membrane was used as the commercial benchmark for comparison.

FIG. 8 is post-synthetic modification of MIL-101 (Cr)—NH₂ nanoparticles resulting in GPTES functionalized MIL-101 (Cr)—NH₂ (i.e., GPTES@MIL-101 (Cr)—NH₂), according to some embodiments.

FIGS. 9A-9D are (9A) pure water permeance and (9B) NaCl rejection at various testing pressures and (9C) water/NaCl selectivity at 150 psi for TFN membranes prepared with different TMC@GPTES@MIL-101 (Cr)—NH₂ particle contents in hexane suspension, according to some embodiments. (9D) Water flux and rejection of the TFNg (0.3) membrane for different salts at 150 psi, according to some embodiments. Water permeance tests were performed using deionized water as the feed, while 2000 ppm salt solutions were used for rejection tests in FIGS. 9B-9D. The Dow SW30XLE membrane was used as the commercial benchmark for comparison.

FIGS. 10A-10D are water flux and salt rejection as a function of (10A) NaCl and (10B) MgCl₂ concentration in the feed solutions, (10C) PEG200 and boric acid rejections and (10D) long-term performance stability tests of the TFNg (0.3) membrane, according to some embodiments. Solutions of 200 ppm PEG200 and 5.0 ppm boric acid with a pH value of 7.5 were used as the feed in FIG. 10C. The Dow SW30XLE membrane was used as the commercial benchmark for comparison. All the tests were performed at 150 psi.

FIG. 11 shows the crystalline structures of the UiO-66-NH₂ MOF nanoparticles, according to some embodiments.

FIGS. 12A-12B show schematics for (12A) postsynthetic modifications of UiO-66-NH₂ nanoparticles with GPTES and TMC and (12B) formation of UiO-66-NH₂-polyamide mixed matrix composite via in situ crosslinking during interfacial polymerization, according to some embodiments.

FIG. 13 shows SEM images of the TFNg membranes prepared with different TMC@GPTES@UiO-66-NH₂ particle loading in hexane suspension, according to some embodiments.

FIG. 14 shows water contact angles for TFNg membranes with different particle loading, according to some embodiments. TFN membranes with UiO-66 particles were prepared under the same conditions for comparison.

FIGS. 15A-15D show water permeance (A, L m⁻² h⁻¹ bar⁻¹) (15A) and NaCl rejection (R, %) (FIG. 15B) at various testing pressures for TFNg. membranes prepared with different TMC@GPTES@UiO-66-NH₂ and UiO-66 particle loadings in hexane suspension, according to some embodiments. Water permeance (A, L m 2 h⁻¹ bar⁻¹) (15C) and NaCl rejection (R, %) (FIG. 15D) at various testing pressures for TFN membranes prepared with different TMC@GPTES@UiO-66-NH₂ and UiO-66 particle loadings in hexane suspension, according to some embodiments. Water permeance tests were performed using deionized water as the feed, while 2000 ppm NaCl solution was used for rejection tests.

FIGS. 16A-16F. (16A) Water/NaCl selectivity at 150 psi for TFNg membranes prepared with different TMC@GPTES@UiO-66-NH₂ particle loadings in hexane suspension, according to some embodiments. (16B) Water flux and rejection for different salts, and water flux and rejection as a function of (16C) NaCl and (16D) MgCl₂ concentration in the feed solutions, (16E) PEG200 and boric acid rejections, and (16F) long-term performance stability tests of the TFNg (0.07) membrane at 150 psi, according to some embodiments. Salt solutions at 2000 ppm were used as the feed in FIGS. 16A, 16B, and 16F. Solutions of 200 ppm PEG200 and 5.0 ppm boric acid with a pH value of 7.5 were used as the feed in FIG. 16E. The Dow SW30XLE membrane was used as the commercial benchmark for comparison.

### DETAILED DESCRIPTION

Membranes and related systems and methods for separation of components in liquids are generally described. The membrane may include particles in a polymer matrix (e.g., a polyamide layer). The particles may include metal-organic framework particles comprising functional groups (e.g., from post-synthetic modification) that can, in some instances, improve the rejection and/or selectivity of the membrane. For example, the metal-organic framework may comprise functional groups bound to hydrophobic groups (e.g., alkyl chains) that assist with suspension stability in nonpolar solvents during membrane fabrication. As another example, the metal-organic framework may comprise functional groups bound to crosslinking agents that facilitate in situ crosslinking of the particles with the polymer matrix, thereby reducing voids in the membrane and/or leaching. In some instances, the membrane is a thin-film nanocomposite membrane (e.g., for separating components like charged species and/or neutral species) formed via, for example, interfacial polymerization in the presence of the particles.

One technique for addressing drawbacks and/or tradeoffs in membranes for liquid separations (e.g., with respect to selectivity versus permeability) is to incorporate fillers (e.g., particles such as nanoparticles) into at least a portion of a membrane. For example, thin-film nanocomposite membranes (“TFN membranes”) can include filler particles (e.g., zeolites, carbon molecular sieves, mesoporous silica, carbon nanotubes, metal oxides) in the active layer of the membrane to increase free volume, although it has been observed that such fillers can in some instances reduce rejection and/or selectivity of the resulting membrane. Particles comprising metal-organic frameworks can be used as fillers in membranes (e.g., to establish sub-nanometer pores/channels that can assist with selectivity). However, particles of metal-organic frameworks can be challenging to incorporate into membranes (e.g., TFN membranes) at least because (1) hydrophilic metal-organic frameworks (which can be desirable for water permeance) can be difficult to disperse in nonpolar solvents (e.g., during fabrication processes such as interfacial polymerization) in a stable manner and (2) particles tend to form defects/voids in the active layer of membranes, which can reduce selectivity.

It has been recognized in the context of this disclosure that one or both of the challenges discussed above can be addressed by including functional groups in the metal-organic frameworks, at least some of which may bond to hydrophobic groups (e.g., such that dispersibility in nonpolar solvents is improved) and/or at least some of which may bond to crosslinking agents (e.g., to promote in situ crosslinking with the polymer of a polymer matrix, thereby reducing or eliminating defects/voids). These techniques, which may be performed via post-synthetic modification of the metal-organic frameworks, may lead to membranes (e.g., TFN membranes) with beneficial performance properties (e.g., for separating charged and/or neutral species in liquids such as water).

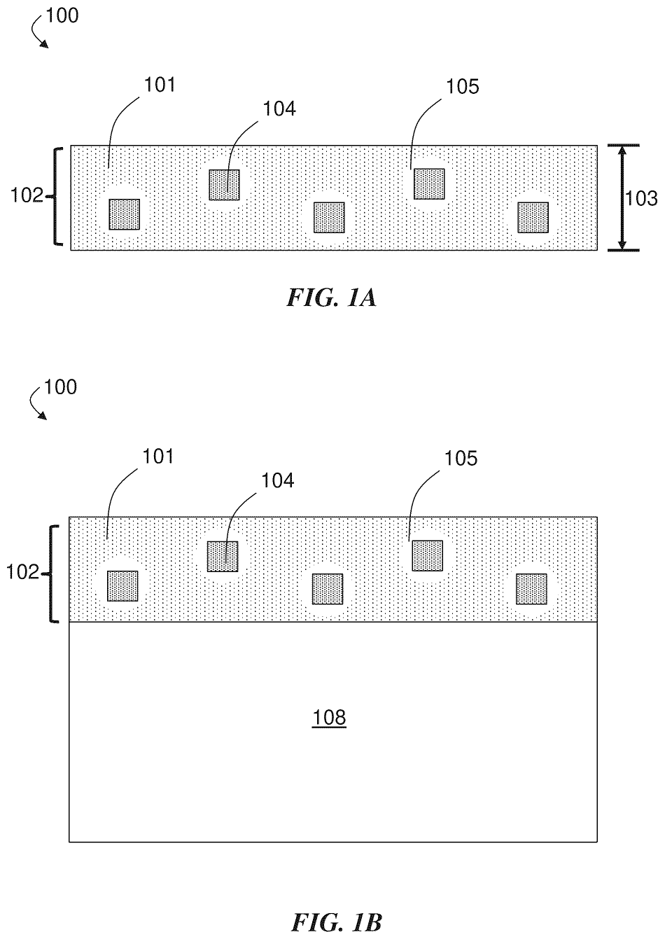

In one aspect, membranes are provided. For example, FIGS. 1A-1B show cross-sectional schematic diagrams of examples of embodiments of membrane 100. In some embodiments, the membrane is a semi-permeable membrane (e.g., a synthetic semi-permeable membrane) that allows certain species (e.g., molecule, ions) to pass through while rejecting the passage of at least some of other species. The membrane may be, for example, a thin-film membrane, such as a thin-film nanocomposite membrane. In some instances, the membrane is suitable for any of a variety of separation processes, such as separating components in liquids (e.g., for nanofiltration and/or osmotic separations).

The membrane can be provided in any of a variety of forms, such a flat sheet membrane, a spiral wound membrane, and/or a hollow fiber membrane.

In some embodiments, the membrane comprises a polymer matrix. Membrane 100 in the embodiments in FIGS. 1A-1B, for example, comprises polymer matrix 101. The polymer matrix may be a material (e.g., a solid material) comprising one or more polymers present in a relatively high amount (e.g., at least 50 wt %, at least 75 wt %, at least 90 wt %, at least 95 wt %, at least 98 wt %, at least 99 wt %, at least 99.9 wt %, or more). In some embodiments, an entirety of the polymer matrix is made up of a single polymer or a combination of polymers. In some instances, one or more other components (e.g., non-polymeric particles and/or residual reagents) are present in at least a portion of the polymer matrix.

In some instances, the polymer matrix serves as a semi-permeable barrier. For example, the polymer matrix may be present as a domain in the membrane (e.g., as a layer of the membrane) that, upon exposure to a liquid containing dissolved and/or suspended species, can block at least some of those species while allowing some of the liquid and/or some of the species to pass through the membrane. In some embodiments, the polymer matrix is part of or an entirety of the active (or selective) domain (e.g., active layer) of a membrane. In some embodiments, the polymer matrix is a scaffold (e.g., a porous scaffold with free volume) to which one or more other materials may be associated (e.g., immobilized with respect to). For example, in some embodiments, particles (e.g., comprising metal-organic frameworks) are present within at least a portion of the polymer matrix. While at least some of the particles may be within the polymer matrix, other of particles may be associated with an exterior of the polymer matrix (e.g., as an external coating). In some embodiments, the polymer matrix is amorphous.

In some embodiments, the polymer matrix comprises free volume. The free volume may be established by regions of volume of the polymer matrix not occupied by the polymer. For example, at least a portion of the polymer matrix may comprise regions of cross-linked polymer chains, where the crosslinking of the chains creates an extended network with free volume present in places unoccupied by the crosslinked polymer chains. The free volume of the membrane may, in some instances, provide pathways through which some species (e.g., liquid species and/or dissolved and/or suspended species) can travel as they permeate the membrane. The free volume of the polymer matrix may be observable using, for example, scanning electron microscopy (SEM). As discussed below, in some embodiments at least some of the particles (e.g., comprising metal-organic frameworks) occupy at least a portion (e.g., at least 5 vol %, at least 10 vol %, at least 25 vol %, at least 50 vol %, at least 75 vol %, at least 90 vol %, and/or up to 95 vol %, or more) of the free volume of the polymer matrix.

As mentioned above, in some embodiments, the membrane comprises a layer comprising the polymer matrix. The layer comprising the polymer matrix may be the active layer of the membrane that determines one or more separation properties of the overall membranes, such as the permeability (e.g., liquid permeability), rejection, and/or selectivity. The polymer matrix may occupy a relatively large percentage of the volume of the layer (e.g., greater than or equal to 10 volume percent (vol %), greater than or equal to 20 vol %, greater than or equal to 40 vol %, greater than or equal to 50 vol %, and/or up to 75 vol %, up to 80 vol %, up to 90 vol %, or more).

Referring again to FIGS. 1A-1B, membrane 100 comprises layer 102 comprising polymer matrix 101, in accordance with some embodiments. The layer comprising the polymer matrix may have a thickness dimension and one or more lateral dimensions perpendicular to the thickness dimension. For example, in FIG. 1A, layer 101 has thickness dimension 103 and one or more lateral dimensions perpendicular to thickness dimension 103 (e.g., a dimension coming out of the plane of the figure). In some embodiments, at least one lateral dimension (e.g., two or more lateral dimensions perpendicular to each other) has a length that is greater than or equal to the thickness dimension (e.g., an average thickness dimension) of the layer comprising the polymer matrix by a factor of at least 3, at least 5, at least 10, at least 20, at least 50, at least 100, at least 1000, and/or up to 2000, up to 5000, up to 10000, up to 100000, up to 1000000, up to 1000000000, up to 10000000000, or more.

In some embodiments, the layer comprising the polymer matrix (e.g., an active layer of a thin-film composite membrane) is relatively thin (e.g., a thin film). Having the layer be relatively thin may contribute to the membrane having a desirable permeability (e.g., water permeability). In some embodiments, the layer comprising the polymer matrix has an average thickness of less than or equal to 250 nm, less than or equal to 200 nm, less than or equal to 150 nm, less than or equal to 100 nm, and/or as low as 50 nm, as low as 25 nm, as low as 20 nm, or lower. Combinations of these ranges are possible. In some embodiments, the layer comprising the polymer matrix has a largest thickness of less than or equal to 250 nm, less than or equal to 200 nm, less than or equal to 150 nm, less than or equal to 100 nm, and/or as low as 50 nm, as low as 25 nm, as low as 20 nm, or lower. Combinations of these ranges are possible. The average and largest thickness of the layer comprising the polymer matrix can be determined using, for example, SEM.

As mentioned above, the polymer matrix may comprise a polymer. The polymer be any of a variety of polymers suitable for, example, for membrane separation processes (e.g., liquid separations. For example, the polymer may have chemical properties making it suitable for separating a desired solute (and/or suspended substance) from a liquid containing the solute. As an example, the polymer may be chemically inert in terms of bond-forming and/or bond-breaking reactions (e.g., covalent bond-forming and/or bond-breaking reactions) with respect to the solute (and/or suspended substance) and the liquid on the timescale of the separation process (although the polymer may still be able to interact with the liquid and solute via, for example electrostatic, hydrophobic, steric, and/or other types of noncovalent interactions to contribute to the separation process). As another example, at least a portion of the polymer may be electrostatically neutral (e.g., such that buildup of charged species in the active layer, which could cause performance problems for the membrane, is reduced or avoided). In some embodiments, the polymer has a chemical structure compatible with passing certain types of liquids through it. For example, in some embodiments, the polymer is suitable for passing water through the polymer matrix (e.g., with a relatively high water permeability). One such way is by having the polymer be hydrophilic (e.g., by comprising one or more polar moieties and/or hydrogen-bonding moieties). In some embodiments, the polymer has a structure such that it can form crosslinks. In some embodiments, the polymer has a structure such that, upon crosslinking, pores are formed that are suitable for one or more separation processes (e.g., on a size scale suitable for nanofiltration and/or osmosis separations such as forward osmosis or reverse osmosis). Those of ordinary skill in the art can readily select polymers and cross linking agents to achieve this: pores of desired average size, range, and/or distribution.

Any of a variety of polymers may be suitable based on, for example, the above criteria. These polymers include, but are not limited to, polyamides (e.g., aromatic polyamides), polyurethanes, cellulosic polymers (e.g., cellulose triacetate), polyalkylene oxide-based polymers (e.g., polyethylene glycol derivatives), polyethersulfone, polysulfone, polyacrylonitrile, polycarbonates, polyvinylidene fluoride, and sulfonated polymers (e.g., sulfonated polyphenylenesulfone and sulphonated poly(etherketone)), and derivatives and/or combinations thereof. As mentioned above, in some embodiments, the polymer is at least partially (or completely) crosslinked.

The polymer matrix may be formed by any of a variety of suitable techniques. For example, the polymer matrix may be formed by interfacial polymerization. Interfacial polymerization may involve contacting two immiscible phases (e.g., two immiscible liquids or a liquid and a solid) such that a polymerization reaction occurs at the interface of the two phases. For example, a first phase may be a polar liquid (e.g., water) and the second phase may be a liquid immiscible with the polar liquid (e.g., a nonpolar liquid such as a nonpolar organic liquid such as hexanes). The first phase may contain a first reagent for the polymerization reaction (e.g., a first monomer and/or a crosslinking agent) and the second phase may contain a second reagent for the polymerization reaction (e.g., a second monomer and/or a second crosslinking agent). The first and second reagents may interact at the interface such that a polymerization reaction occurs (e.g., via polycondensation or any of a variety of other mechanisms). In some embodiments, the interface at which the polymerization occurs is established at least in part by the interface between at least one liquid and a solid such as the porous support layer described below. Other potentially suitable techniques include, but are not limited to melt polymerization and photo-polymerization (e.g., by including photo-active monomers such as acrylic acids/acrylates). In some embodiments, at least a portion of the polymer matrix is formed in the presence of the particles comprising the metal-organic frameworks and/or a porous support layer.

As mentioned above, the membrane may comprise particles (e.g., comprising metal-organic frameworks). The particles may be associated with the polymer matrix. For example, at least some of the particles reside within the polymer matrix. Referring again to FIGS. 1A-1B, membrane 100 may comprise particles 104, at least some of which reside in free volume (e.g., channels) 105 of polymer matrix 101. In some embodiments, at least some of the particles are attached to at least a portion of the polymer matrix (e.g., via a covalent or noncovalent interaction). The particles may occupy at least a portion of free volume within the polymer matrix not occupied by the polymer of the polymer matrix. The particles may promote beneficial performance of the membrane. For example, the particles may comprise channels (e.g., from pores) having an appropriate size to allow for any of a number of separation processes (e.g., liquid separations, gas separations, liquid-solute separations, liquid-suspended phase separations). For example, the particles may comprise channels (e.g., from pores) having a sub-nanoscale size smaller than species for which passage through the membrane is undesired (e.g., largest cross-sectional dimensions perpendicular to the channel length dimension less than 1 nm, less than 0.8 nm, less than or equal to 0.7 nm, and/or as low as 0.6 nm, as low as 0.5 nm, as low as 0.4 nm, as low as 0.3 nm, as low as 0.2 nm, or less). In some embodiments, the particles promote a greater hydrophilicity of the membrane as compared to a membrane lacking the particles. In some embodiments, the presence of the particles promotes a higher O/N atomic ratio and/or a greater degree of polymer matrix crosslinking as compared to a membrane lacking the particles.

In some embodiments, the particles (e.g., comprising metal-organic frameworks) are present in the polymer matrix in a relatively high amount. Some aspects of this disclosure, such as the inclusion of hydrophobic groups and/or crosslinking agents bonded to functional groups of the metal-organic frameworks, may contribute to a relatively high loading of the particles in the polymer matrix. In some embodiments, the particles are present in the polymer matrix in an amount of at least 0.05 wt %, at least 0.1 wt %, at least 0.5 wt %, at least 1 wt %, at least 2 wt %, at least 5 wt %, at least 10 wt %, at least 20 wt %, at least 40 wt %, at least 50 wt %, and/or up to 60 wt %, up to 75 wt %, or more by total weight of the polymer matrix and the particles. Combinations of the above ranges are possible.

The particles may comprise a metal-organic framework. Metal-organic frameworks generally refer to a class of compounds having metal ions or clusters coordinated to ligands to form extended structures (e.g., one-, two-, or three-dimensional structures). The metal-organic framework may form a coordination network having voids (which may establish channels). The voids (e.g., channels) may allow for the passage of some species but not others (e.g., by size exclusion). Accordingly, particles comprising metal-organic frameworks may assist with promoting selectivity and/or desirable rejection rates for the membrane while, in some instances, contributing sufficient free volume to allow for desirable permeate to pass through (e.g., liquid such as water and/or other solute).

In some embodiments, the metal-organic framework comprises a metal ion. The metal ion can generally be any metal ion capable of binding a ligand. For example, the metal ion can, in accordance with certain embodiments, be chromium (e.g., Cr³⁺), zirconium (e.g., Zr⁴⁺), cadmium (e.g., Cd²⁺), zinc (e.g., Zn²⁺), copper (e.g., Cu⁺), aluminum (e.g., Al³⁺), or magnesium (e.g., Mg²⁺), gallium (e.g., Ga³⁺), indium (e.g., In³⁺), and cerium (e.g., Ce⁴⁺). In some embodiments, the metal ion is zinc. In some embodiments, the metal ion is a transition metal ion. Non-limiting examples of transition metal ions that can be included in the metal-organic framework include, in accordance with certain embodiments, iron (e.g., Fe²⁺, Fe³⁺), copper, cobalt (e.g., Co²⁺), nickel, manganese (e.g., Mn²⁺), zirconium, chromium, silver (e.g., Ag⁺), scandium (e.g., Sc³⁺), vanadium (e.g., V³⁺), titanium (e.g., Ti⁴⁺), hafnium (e.g., Hf⁴⁺). In some embodiments, the metal ion is chromium. In some embodiments, the metal ion is zirconium. The metal ion may be chosen based on any of a variety of criteria, such as propensity to form open coordination sites or to lack open coordination sites, propensity of open coordination sites to bind potential solute (e.g., metal ions dissolved in liquid such as water), and the like.

In some embodiments, the metal-organic framework comprises a multidentate ligand (e.g., a multidentate organic ligand. A multidentate ligand may comprise at least two moieties capable of binding to Lewis acids (e.g., metal ions). In some embodiments, the multidentate ligand is an organic molecule. A multidentate ligand may be able to bind at least two, at least three, or at least four metals. In some embodiments, the multidentate ligand comprises at least two carboxylate groups. Non-limiting examples of some such group include benzene-1,3,5-tricarboxylate, benzene-1,4-dicarboxylate, biphenyl-4,4′-dicarboxylate, triphenyl-4,4′-dicarboxylate, naphthalene-2,6-dicarboxylate, 1,3,5-tris(carboxyphenyl)benzene, terephthalate, 2,5-dioxido-1,4-benzenedicarboxylate, and 5,5′-(9,10-anthracenediyl)di-isophthalate, and derivatives thereof. In other embodiments, the multidentate ligand does not comprise multiple carboxylate groups. The metal ion and the multidentate ligand may be selected such that the resulting MOF has a void (e.g., channel) size that is appropriate for a liquid separation process (e.g., less than or equal to 1 nm and/or as low as 0.1 nm).

The particles can comprise a variety of classes of metal-organic frameworks. In some embodiments, the particles comprise carboxylate-based metal-organic frameworks. Carboxylate-based metal-organic framework generally comprise multidentate ligands comprising at least two carboxylate groups. In some embodiments, the metal-organic framework comprises a Universitetet i Oslo-series (UiO-series) metal-organic framework (e.g., UiO-66-type, UiO-67-type, UiO-68 type). In some embodiments, the metal-organic framework comprises a terephthalate framework. For example, in some embodiments, the metal-organic framework comprises a Materiaux de l′Institut Lavoisier-series (MIL-series) metal-organic framework (e.g., MIL-53-type, MIL-96-type, MIL-100-type, MIL-101-type, MIL-125-type), such as a chromium containing MIL-series metal-organic framework. For example, in some embodiments, the MOF comprises MIL-101 (Cr). Other examples of classes of metal-organic frameworks that can be suitable for inclusion in the particles include, but are not limited to, zeolitic imidazolates (e.g., ZIF-8), HKUST-1, MOF-74, triazine-2,4,6-triyl-tribenzoic (TATB) frameworks (e.g., FeTATB, CaTATB, EuTATB, TbTATB), porous coordination networks (PCN) (e.g., PCN-333), and metal-organic framework-74. In some embodiments, the branched nanoparticles comprise HKUST-1, which is a carboxylate-based metal-organic framework. The metal-organic framework names listed here are generally known to those familiar with metal-organic frameworks. Other examples of metal-organic frameworks that can, in some instances, be used for the particles and also examples of methods of synthesizing metal-organic frameworks are described in U.S. Patent Application Publication No. 2019-0352243, published on Nov. 21, 2019, which is incorporated herein by reference. Modified metal-organic frameworks, which may include multidentate ligands that have been derivatized via the addition of various functional groups (e.g., hydroxy groups, alkyl groups, amine groups, halo groups, thio groups, nitro groups, etc.), as well as metal-organic frameworks in which at least a portion of the metals have been substituted with different metals (e.g., zinc substituted with magnesium) may also be used in the particles. Whether a metal-organic framework is suitable or unsuitable can be determined, for example, based on knowledge of the chemical compatibility of the metal-organic framework with the substances (e.g., liquids and solutes) to which the membrane is to be exposed, as well as, for example, the ability of the metal-organic framework to accommodate the functional groups described in this disclosure (and in some instances the post-synthetic modifications described in this disclosure).

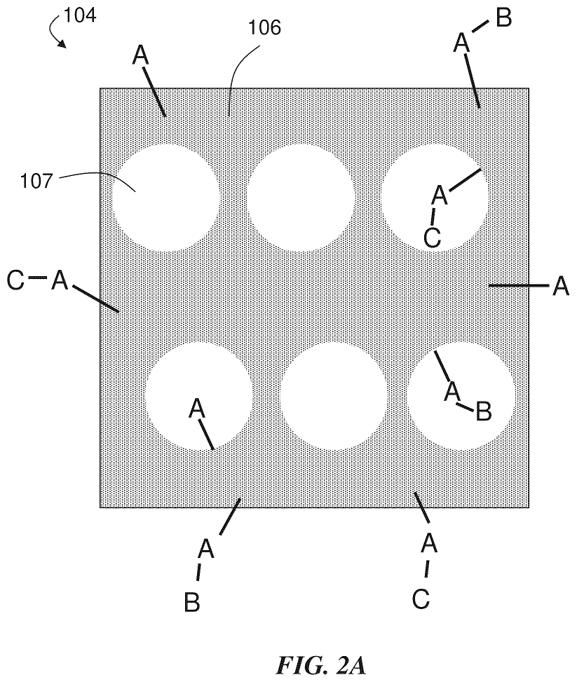

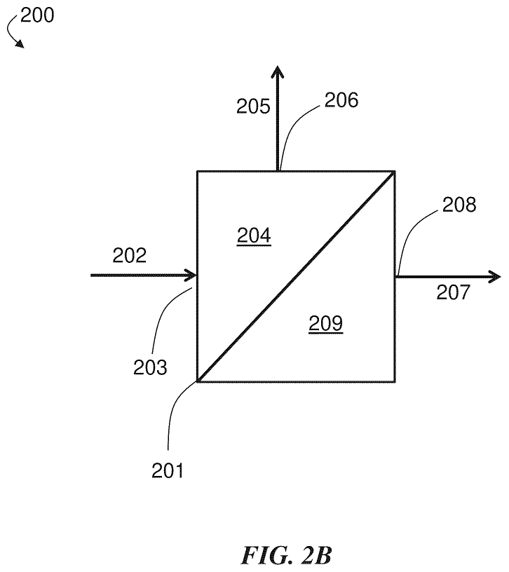

As noted above, the metal-organic framework may comprise functional groups. For example, FIG. 2A shows a cross-sectional schematic diagram of particle 104, which may comprise functional groups A. The functional groups may be an intrinsic part of the metal-organic framework (e.g., a functional group on a typical ligand of the metal-organic framework that does not bind a metal ion) or the functional groups may be included as modifications to the ligands before, during, and/or after synthesis of the metal-organic framework. For example, the functional group may be included by derivatizing the multidentate ligand using standard organic chemistry techniques or in some instances purchased as a commercially available derivative. In some embodiments, the functional group is capable of reacting with other reactive functional groups (e.g., of other reagents). For example, the functional groups may be capable of participating in a nucleophilic addition reaction or a substitution reaction (e.g., by being nucleophile or an electrophile). As another example, the functional group may be capable of participating in a condensation reaction. Examples of the functional groups include amine groups, carboxylate groups, thio groups, halo groups, hydroxy groups, azide groups, alkenyl groups, alkynyl groups, nitro groups, aldehyde groups, ketone groups, cyano groups, epoxide groups, and/or aromatic groups. In some embodiments, the functional groups all have the same chemical structure, while in other embodiments some of the functional groups have a different structure than other of the functional groups. In some embodiments, at least some (e.g., at least 20 mole percent (mol %), at least 50 mol %, at least 75 mol %, at least 90 mol %, at least 95 mol %, at least 98 mol %, at least 99 mol %, or all) of the functional groups are hydrophilic functional groups, which may be, for example polar groups and/or hydrogen bonding groups (e.g., amine groups, hydroxy groups, carboxylate groups, thio groups, aldehyde groups, and/or ketone groups).

At least some of the functional groups may be located on an external surface of the particle comprising the metal-organic framework. For example, FIG. 2A shows some of functional groups A on external surface 106 of particle 104. In some embodiments, at least some of the functional groups are in one or more channels of the particles (e.g., channels of the metal-organic framework of the particles). For example, in FIG. 2A at least some of functional group A are within channels 107 of particle 104. In some embodiments, at least some of the functional groups are located on an external surface of the particle (and can, in some instances, bond to other species such as hydrophobic species and/or crosslinking agents) and at least some of the functional groups are located in one or more channels of the metal-organic framework (and can, in some instances, be accessible to species traveling through the channel of the metal-organic framework). It may be advantageous in at least some embodiments for functional groups in the channels of the metal-organic framework to be hydrophilic such that water may readily pass through channels, which in turn may promote relatively high water permeance of the particles and consequently the membrane. The hydrophilic groups may be charged (e.g., a negatively charged carboxylate group) or uncharged (e.g., an amine group).

At least some of the functional groups of the metal-organic framework may be free functional groups that are not bonded (e.g., covalently or noncovalently) to other groups. For example, at least some (e.g., at least 20 mol %, at least 50 mol %, at least 75 mol %, at least 90 mol %, at least 95 mol %, at least 98 mol %, at least 99 mol %, or all) of the functional groups may be free hydrophilic groups such as free amine groups or free carboxylate/carboxylic acid groups). In some embodiments, at least some of the functional groups are free amine groups (e.g., free primary amine groups). In some embodiments, at least some (e.g., at least 20 mol %, at least 50 mol %, at least 75 mol %, at least 90 mol %, at least 95 mol %, at least 98 mol %, at least 99 mol %, or all) of the functional groups are bonded (e.g., covalently or noncovalently) to other groups. For example, in some embodiments at least some of the functional groups are primary amine groups that have reacted with an epoxide group (e.g., of a hydrophobic group), thereby generating a secondary amine group bound to a carbon atom formerly of the epoxide group. As another example, in some embodiments at least some of the functional groups are primary amine groups that have reacted with an acid halide group (e.g., of a crosslinking agent) via a nucleophilic addition reaction, thereby generating an amide group (e.g., connecting the metal-organic framework to a remainder of the crosslinking agent).

In some embodiments, a plurality of the functional groups are bonded (e.g., covalently or noncovalently) to a hydrophobic species. The hydrophobic species may have an ability to promote dissolution or attraction fats, oils, lipids, and/or nonpolar liquids. In some embodiments, the Log P of the hydrophobic species (when in molecular form) determined at 298 K and 1 atm is greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, greater than or equal to 10, or greater. The “Log P” of a molecule is the logarithm (Log) of the molecule's partition coefficient (P), which is the ratio of molar concentrations of the molecule in a mixture of n-octanol and water at equilibrium. The molecule's Log P is determined according to the equation Log P=Log ((Concentration of the molecule in the n-octanol phase of the mixture)/(Concentration of the molecule in the water phase of the mixture)). A higher Log P may be associated with a greater hydrophobicity.

This plurality of the functional groups bonded to a hydrophobic species may be located on the external surface of the particles and/or in the channels of the metal-organic framework. For example, in FIG. 2A, some of functional groups A are bonded to hydrophobic groups B, with some such functional groups A on external surface 106 and some such functional groups A in channels 107. It has been recognized that association of hydrophobic groups to the metal-organic framework (e.g., on an external surface of the particle) can, in some instances, improve the dispersibility and/or suspension stability of the particles in nonpolar liquids (e.g., by reducing or eliminating aggregation that may otherwise be observed with particles having a primarily hydrophilic external surface instead). By having a plurality of hydrophobic groups introduced to the particles (e.g., by post-synthetic modification of some of the functional groups of the metal-organic framework), it can be possible to have particles with hydrophobic surfaces and hydrophilic channels, which may allow for particles that can be well-dispersed in nonpolar liquids during membrane synthesis but maintain a relatively high water permeability.

The hydrophobic species may comprise any of a variety of groups tending to make the species hydrophobic. In some embodiments, the hydrophobic species comprises one or more nonpolar groups. Groups tending to make a species hydrophobic include, but are not limited substituted or unsubstituted, branched or unbranched alkyl groups having 1 to 50 carbon atoms. In certain embodiments, group (e.g., alkyl group) may include at least 1, at least 6, at least 12, at least 18, at least 24, at least 36, or at least 50 carbon atoms. In certain embodiments, the group (e.g., alkyl group) includes at most 50, at most 36, at most 24, at most 18, at most 12, or at most 6 carbon atoms. Combinations of these ranges (e.g., at least about 1 and at most about 24 carbon atoms) are possible. In certain embodiments, the group is unsubstituted alkyl. In certain embodiments, the group is unsubstituted and unbranched alkyl. In certain embodiments, the group is unsubstituted and unbranched C₁₋₂₄ alkyl. In certain embodiments, the group is unsubstituted and unbranched C₆₋₂₄ alkyl. In certain embodiments, the group is unsubstituted and unbranched C₁₂₋₂₄ alkyl. In some embodiments, the group is any of the above groups in which some or all of the hydrogens are substituted with fluorine atoms (e.g., a fluorocarbon group). In some embodiments, the group tending to make the species hydrophobic is an aromatic group (e.g., an aryl group). In some embodiments, the hydrophobic species comprises a silicon-containing species. For example, the hydrophobic species may comprise a silane (e.g., an alkoxysilane). In some embodiments, the hydrophobic species comprises a silicon-containing group (e.g., a silane) bonded to a substituted or unsubstituted alkyl chain. For example, the hydrophobic species may be a (3-glycidyloxyalkyl)trialkoxysilane, where the alkyl groups can independently be C₁₋₁₈ (e.g., C₁₋₈, C₁₋₄) alkyl. As one example, the hydrophobic species may be (3-glycidyloxypropyl)triethoxysilane (GPTES). It should be understood that in this context when it is stated that the functional group may be bonded to a (3-glycidyloxyalkyl)trialkoxysilane, this phrasing is used for convenience, as the glycidyl group may no longer be present due to the reaction between the functional group (e.g., an amine group) and the epoxide of the glycidyl group.

In some embodiments, the hydrophobic groups are sufficiently large such that they cannot be incorporated into at least some channels of the metal-organic framework. This may result in the surface of the particles having a greater extent of functionalization with the hydrophobic groups than the channels, which may allow for the particles to generally have hydrophobic external surfaces (which may promote stable suspensions in nonpolar solvents during fabrication) and hydrophilic channels (which may promote good water permeance).

The hydrophobic species may be bonded to the functional groups of the metal-organic framework by reacting the functional group with a reactive group of the hydrophobic species. For example, the functional group on the metal-organic framework may be a nucleophile, and the hydrophobic specie may comprise an electrophilic group capable of reacting with the nucleophile (e.g., under readily accessible synthesis conditions), such that a nucleophilic substitution, addition, or condensation reaction can occur. As another example, the functional group on the metal-organic framework may be an electrophile, and the hydrophobic specie may comprise a nucleophilic group capable of reacting with the electrophile (e.g., under readily accessible synthesis conditions), such that a nucleophilic substitution, addition, or condensation reaction can occur. As yet another example, the functional group of the metal-organic framework may be a nucleophilic group, and the hydrophobic species may comprise a carbonyl group, such that a nucleophilic addition reaction can occur. The functional groups may be bonded to the hydrophobic groups before and/or during the fabrication of at least a portion of the membrane. For example, the membrane may be fabricated via an interfacial polymerization reaction involving providing the particles comprising the metal-organic framework suspended in a solution comprising a nonpolar liquid (e.g., hexanes), and the hydrophobic groups may be introduced to the particles (e.g., the external surface of the particles) prior to the particles being contacted to the nonpolar liquid so that the hydrophobic particles assist with promoting good dispersion and/or stability of the suspension of the particles within the nonpolar liquid.

It can be advantageous to select the polymer of the polymer matrix in combination with the metal-organic framework, the functional groups, and the hydrophobic species such that their interactions contribute to a membrane with a relatively high loading of the particles in the polymer matrix such as one of the ranges described in this disclosure (e.g., due to the particles forming a sufficiently stable suspension in a precursor solution (e.g., comprising a nonpolar liquid).

In some embodiments, a plurality of the functional groups are bonded (e.g., covalently or noncovalently) to a crosslinking agent. The crosslinking agent may have an ability to form a first bond (covalent or noncovalent bond) with a first group (e.g., the functional group of the metal-organic framework) and a second bond (covalent or noncovalent bond) with a second group (e.g., a portion of the polymer matrix). For example, the crosslinking agent may be an organic species comprising multiple reactive groups (that may be the same or different) such that the crosslinking agent can link two separate groups. In some embodiments, the crosslinking agent is a click chemistry reagent (e.g., a species that facilitates click chemistry). For example, in some embodiments, the crosslinking agent is an azide click chemistry reagent (e.g., a species that facilitates azide click chemistry). Azide click chemistry may involve reaction of an azide group with an alkynyl group to form a heteroatom ring such as a triazole ring (e.g., catalyzed by copper). As such, in some embodiments, the functional groups on the metal-organic framework comprise azide groups and the crosslinking reagent has at least one (or at least two, or more) alkynyl groups. As another example, in some embodiments, the functional groups on the metal-organic framework comprise alkynyl groups and the crosslinking reagent has at least one (or at least two, or more) azide groups. As another example, the crosslinking agent may be a metal ion capable of forming electrostatic linkages between different groups (e.g., a calcium ion).

This plurality of the functional groups that may bond to a crosslinking agent may be located on the external surface of the particles and/or in the channels of the metal-organic framework. For example, in FIG. 2A, some of functional groups A are bonded to crosslinking agents C, with some such functional groups A on external surface 106 and some such functional groups A in channels 107. In some embodiments, the crosslinking agent is an organic group comprising at least two, at least three, or more reactive groups (e.g., electrophilic groups and/or nucleophilic groups) located such that the organic group can form a linkage. For example, the crosslinking agent may comprise or be a reaction product of an organic linker such as an aromatic group having two or more reactive substituents. At least some of the reactive substituents may be an electrophile such as an acid halide group (e.g., an acid chloride, an acid bromide, an acid iodide). One specific such example is trimesoyl halide (e.g., trimesoyl chloride). It should be understood that in this context when it is stated that the functional group may be bonded to a crosslinking agent that comprises or is a reaction product of an acid halide group, this phrasing is used for convenience, as the acid halide group may no longer be present due to the reaction between the functional group (e.g., an amine group) and the acid halide, and the resulting species following the bonding is instead the functional group bound to a carbonyl group (e.g., an amide group).

In some embodiments, at least some of the crosslinking agents bound to the functional groups of the metal-organic framework are the same type of species (e.g., same chemical structure) as at least some of the monomers from which the polymer of the polymer matrix is formed. For example, in some embodiments, the polymer matrix is a polyamide formed by the reaction of trimesoyl chloride (TMC) and m-phenylenediamine (MPD). In some such embodiments, a plurality of the functional groups of the metal-organic framework (e.g., amine groups) bond to TMC groups. In some embodiments, the crosslinking agent is bound to the polymer matrix, thereby resulting in the metal-organic framework being attached to the polymer matrix. For example, the functional group of the metal-organic framework may be bonded to a first reactive group of the crosslinking agent, and the polymer matrix may be bonded to a second reactive group of the crosslinking agent. Referring to the example embodiment above, a first acid chloride of the TMC group may bond with a functional group (e.g., amine group) of the metal-organic framework, and a second (and in some instances third) acid chloride group of the TMC may bond to the polyamide of the polymer matrix. The crosslinking of the particles comprising the metal-organic framework with the polymer matrix may reduce or eliminate defects/voids in the free volume of the polymer matrix and/or reduce or eliminate leaching of the particles from the polymer matrix, which may improve the performance of the membrane in terms of selectivity and/or rejection. Additionally, it has been recognized that the crosslinking of the particles to the polymer matrix may assist with mechanical stability of the membrane.

The functional groups of the metal-organic framework may be bonded to the crosslinking agents before and/or during the fabrication of at least a portion of the membrane. For example, the membrane may be fabricated by providing (e.g., suspending) particles comprising the metal-organic framework in a solution comprising the crosslinking agent. In some such embodiments, the particles and the crosslinking agent from the solution are exposed to a polymer or a monomer thereof (e.g., a building block of the polymer matrix). The polymer or monomer thereof maybe, for example, a polyamide or a diamine such as m-phenylenediamine. This may be performed such that at least some of the particles become crosslinked to a matrix of the polymer via a reaction between (a) crosslinking agent that is or becomes bonded to a plurality of the functional groups and (b) the polymer or a monomer thereof. In some such instances, at least some of the functional groups are bonded with the crosslinking agent before at least some of the particles are exposed to the polymer and/or monomer thereof. For example, the metal-organic framework of the particles in the solution (e.g., comprising a nonpolar solvent such as hexanes) may comprise some functional groups (e.g., amine groups) already bound to the crosslinking agent (e.g., TMC), but where the bound crosslinking agent still contains reactive groups capable of crosslinking with the polymer or monomer thereof once exposed to the polymer or monomer thereof (e.g., at an interface between the solution and a second phase). In some such instances, the solution (e.g., comprising the nonpolar liquid) also comprises crosslinking agent (e.g., dissolved in the solution) that is unbound to any species. In some embodiments, at least some of the functional groups are bonded with the crosslinking agent during or after exposure of at least some of the particles to the polymer or monomer thereof. For example, some functional groups of the metal-organic framework may be free functional groups at the time the metal-organic framework is exposed to the polymer and/or monomer thereof (e.g., during interfacial polymerization), and those free functional groups may at that time bond to unbound crosslinking agents and/or crosslinking agents already bound to the polymer of the polymer matrix. Either or both of these types of bonding of the functional groups may occur, and may result in the particles being crosslinked with the resulting matrix.

It can be advantageous to select the polymer of the polymer matrix in combination with the metal-organic framework, the functional groups, and the crosslinking agent such that their interactions contribute to a membrane loaded with the particles in the polymer matrix with few or no defects/voids with respect to the particles in the matrix (which can, in some instances, result in one or more of the performance attributes describes in more detail below).

It can be advantageous to select the polymer of the polymer matrix in combination with the metal-organic framework, the functional groups, the hydrophobic species, and the crosslinking agent (if both the hydrophobic species and the crosslinking agents are used) such that their interactions contribute to a membrane with (a) a relatively high loading of the particles in the polymer matrix such as one of the ranges described in this disclosure (e.g., due to the particles forming a sufficiently stable suspension in a precursor solution (e.g., comprising a nonpolar liquid) and (b) a membrane loaded with the particles in the polymer matrix with few or no defects/voids with respect to the particles in the matrix (which can, in some instances, result in one or more of the performance attributes describes in more detail below).

The particles of the membrane (e.g., comprising the metal organic framework) may have any of a variety of shapes and sizes. Examples of shapes of the particles include, but are not limited to, prismatic (e.g., cubic), needle-shaped, spherical, polyhedral (regular or irregular), disk-like, cylindrical, branched, and/or unbranched. The particles may be sufficiently small such that they can be incorporated into the free volume of the polymer matrix, but large enough such that they can effectively assist with separations (e.g., via size exclusion). At least some of the particles may be, for example, nanoparticles. In some embodiments, the particles have an average largest cross-sectional dimension of less than or equal to 150 nm, less than or equal to 100 nm, less than or equal to 80 nm, less than or equal to 500 nm, less than or equal to 40 nm, less than or equal to 20 nm, and/or as low as 15 nm, as low as 10 nm, as low as 5 nm, as low as 2 nm, or lower. Combinations of these ranges are possible. The average largest cross-sectional dimension of the particles can be determined via, for example, transmission electron microscopy (TEM)

In some embodiments, the membrane further comprises a porous support layer. As such, the membrane may be a composite membrane (e.g., a thin-film composite membrane) comprising the layer comprising the polymer matrix and the porous support layer. The porous support layer may be adjacent to the layer comprising the polymer matrix. For example, in the embodiment shown in FIG. 1B, membrane 100 comprises porous support layer 108 adjacent to layer 102 comprising polymer matrix 101. The porous support layer may be directly adjacent to the layer comprising polymer matrix such that no intervening materials are between porous support layer and the layer comprising the polymer matrix. However, in some embodiments the porous support layer in indirectly adjacent to the layer comprising the polymer matrix (e.g., such that one or more other layers is between the porous support layer and the layer comprising the polymer matrix). The porous support matrix may provide mechanical support for the membrane while having sufficient porosity such that it does not reduce the permeability of the layer comprising the polymer matrix (e.g., with respect to a liquid such as water).

The porous support layer may be formed from any of a variety of a materials. For example, the porous support layer may comprise a polymer. The polymer of the porous support layer may be different than that of the polymer matrix or it may be the same (e.g., but with a different porosity and/or crosslinking extent). The material of the porous support layer may be inert with respect to components to which the membrane is to be exposed (e.g., liquid such as water or organic solvents, solute such as ions or neutral molecules). Examples of polymers that the porous support layer may comprise include, but are not limited to, polyethersulfone, polysulfone, polyphenylsulfone, polyvinylidene fluoride, polyacrylonitrile, polypropylene, polytetrafluoroethylene, poly(ether ether ketone), polyimide, cellulose acetate, polycarbonate, polyethylene, and combinations thereof. The porous support layer may be woven or nonwoven.

The porous support layer may be relatively thick as compared to the layer comprising the polymer matrix. In some embodiments, the porous support layer has a thickness of greater than or equal to 1 micron, greater than or equal to 10 microns, greater than or equal to 20 microns, greater than or equal to 30 microns, greater than or equal to 40 microns, greater than or equal to 50 microns, and/or up 100 microns, up to 200 microns, up to 300 microns, or greater. Combinations of these ranges are possible.

In some embodiments, the layer comprising the polymer matrix and the particles (e.g., comprising the metal-organic framework) is fabricated in the presence of the porous support membrane. For example, the layer comprising the polymer matrix and the particles may be deposited on the porous support membrane in situ during the formation of the polymer matrix (e.g., by having the porous support membrane present during an interfacial polymerization step or other fabrication step such as photopolymerization step).

The membranes described in this disclosure may be useful for any of a variety of applications. For example, the membrane may be configured for use in a liquid separation process (e.g., water desalination, separation of organic liquids from water, separation of organic liquids/components from other organic liquids/components, gas separations). In some embodiments, the membrane is configured for a nanofiltration process (e.g., by having a pore or void structure of sufficient size). In some embodiments, the membrane is configured for an osmotic process (e.g., by having a pore or void structure of sufficiently small size). Some embodiments involve exposing the membrane to a solution (e.g., comprising a liquid and a solute) and passing a first portion of the liquid (and in some instances some of the solute) through the membrane while rejecting a portion of the solute (and in some instances some of the liquid).

It has been recognized in the context of this disclosure that the inclusion of the particles in the polymer matrix (e.g., with functional groups promoting inclusion of hydrophobic groups and/or crosslinking agents to reduce voids/defects) may provide for membranes that can reject any of a variety of species, including solutes otherwise difficult to reject. For example, relatively small neutral species such as small PEG-based molecules, ureas, and/or boric acid may be desirable to remove from some solutions, but may normally be difficult to reject owing to their charged neutrality. It has been observed in this disclosure that such neutral species may be removable from solutions using at least some membranes described in this disclosure. Other examples of neutral species that the membrane may be able to remove include, but are not limited to neutral organic molecules (e.g., organic contaminants such as hydrocarbon contaminants) and fluorine-containing molecules (e.g., per- and polyfluoroalkyl substances (PFAS)). Charged species that the membrane may be able to remove include, but are not limited to monovalent cations (e.g., lithium cation, sodium cation, potassium cation), divalent cations (e.g., magnesium cation, calcium cation, strontium cation), monovalent anions (e.g., chloride anion, bromide anion, iodide anion, nitrate anion, perchlorate anion), divalent cations (e.g., sulfate anion), and heavy metals (e.g., lead, arsenic, mercury, cadmium, zinc, silver, copper, iron, chromium, nickel, palladium, platinum).

It should be understood that the membrane performance properties described here and below correspond to properties at room temperature (˜298 K). The determination of the properties here and below can be performed using measurement techniques consistent with those described in the Examples below. In some embodiments, the membrane has a relatively high rejection of one or more species. In some embodiments, the membrane (e.g., thin film nanocomposite membrane) has a rejection of NaCl (e.g., dissolved in water) of 95% or greater, 96.1% or greater, 98% or greater, 98.5% or greater, 99% or greater, or greater. In some embodiments, the membrane (e.g., thin film nanocomposite membrane) has a rejection of MgCl₂, MgSO₄, and/or Na₂SO₄ (e.g., dissolved in water) of 98% or greater, 99% or greater, or greater. In some embodiments, the membrane (e.g., thin film nanocomposite membrane) has a water flux of 1.8 L m⁻² h⁻¹ or greater, 2 L m⁻² h⁻¹ or greater, 2.5 L m⁻² h⁻¹ or greater, 3 L m⁻² h⁻¹ or greater, 4 L m⁻² h⁻¹ or greater, 5 L m⁻² h⁻¹ or greater, 5.6 L m⁻² h⁻¹ or greater, and/or up to 6 L m⁻² h⁻¹, or greater at 150 psi. In some embodiments, the membrane (e.g., thin film nanocomposite membrane) has a water permeance of 0.9 L m⁻² h⁻¹ bar-1 or greater, 1 L m⁻² h⁻¹ bar-1 or greater, 1.3 L m⁻² h⁻¹ bar-1 or greater, 2 L m⁻² h⁻¹ bar-1 or greater, 5 L m⁻² h⁻¹ bar-1 or greater, 8 L m⁻² h⁻¹ bar-1 or greater at 150 psi. In some embodiments, the membrane (e.g., thin film nanocomposite membrane) has a rejection of a PEG species (e.g., PEG200) of 99.2% or greater at 150 psi. In some embodiments, the membrane (e.g., thin film nanocomposite membrane) has a rejection of boric acid of 89% or greater, 90% or greater, 92% or greater, of 95% or greater, or greater at a pH value of 7.5 at 150 psi. Combinations of these ranges are possible.

One aspect of this disclosure relates to systems for performing separations (e.g., for separating ions and/or uncharged solutes in liquids such as water). The system may comprise a filtration unit. It should be understood that while the term filtration is used here for convenience, any of a variety of mechanisms of separation may be accomplished by the filtration unit (e.g., osmotic separation, nanofiltration, dialysis, electrodialysis). The filtration unit may be a vessel (e.g., a cartridge) comprising one or more of the membranes of this disclosure (e.g., one or more thin-film nanocomposite membranes). The filtration unit may comprise a retentate side and a permeate side established by the one or more membranes. In some embodiments, the retentate side has an inlet and an outlet. In some embodiments, the permeate side has an outlet and, optionally, an inlet. FIG. 2B shows a schematic diagram of system 200 comprising filtration unit 201, according to some embodiments. Filtration unit 201 may be configured to receive liquid feed 202 pumped (e.g., via a pump) to inlet 203 of retentate side 204. The liquid feed may comprise any of a variety of solutions such as an aqueous solution comprising a solute. The filtration unit may be configured to produce liquid at the outlet of the permeate side. For example, in FIG. 2B, filtration unit 201 may be configured to produce liquid output stream 205 at outlet 206 of retentate side 204 and also to produce liquid output stream 207 at outlet 208 of permeate side 209. The liquid at the outlet of the permeate side may have a solute concentration that is substantially less (e.g., at least 10% less, at least 20% less, at least 50% less, at least 75% less, at least 80% less, at least 85% less, at least 90% less, at least 95% less, at least 99% less) than the liquid feed. For example, a portion of liquid from liquid feed 202 may pass from retentate side 204, through the membrane, and to permeate side 209 and out of outlet 208 to produce some or all of liquid output stream 207 (which as substantially less solute than liquid feed 202), while at the same time liquid output stream 205 comprises components of the liquid feed rejected by the membrane of filtration unit 201.

The system may be configured to perform any of a variety of separations. For example, the system may be configured to filter water and/or to separate ions and uncharged solutes in water.

U.S. Provisional Patent Application No. 63/342,122, filed May 15, 2022, and entitled “Thin-Film Nanocomposite Membranes for Separating Ions and Uncharged Species in Water,” is incorporated herein by reference in its entirety for all purposes.

The following examples are intended to illustrate certain embodiments of the present invention, but do not exemplify the full scope of the invention.

### Example 1

What is disclosed in this Example is a generalizable approach for controlling interfacial defects and particle agglomeration in the fabrication of polyamide TFN membranes. High-performance TFN membranes with molecular level size-exclusion selectivity toward both ions and small neutral contaminants were fabricated, yielding unprecedented property sets that rival commercial TFC membranes. In situ chemical crosslinking of amine-functionalized MOFs with the polyamide layer was performed to enhance the polymer-MOF compatibility and effectively eliminate interfacial defects. On the other hand, (3-glycidyloxypropyl) triethoxysilane (GPTES) surface modification on MOF fillers was employed to improve their dispersion in hexane and stabilize the filler suspension. As a result, particle agglomeration was significantly suppressed and the particle loading in the polyamide layer increased without forming non-selective voids. A series of characterization studies were performed on the as-synthesized and functionalized MOF fillers as well as the resulting TFN membranes to glean molecular-level insights on how this approach influences membrane formation and structure-property relationships. To investigate more relevant conditions for industrial development, the TFN membranes were also investigated using various inorganic salts and small neutral molecules as probe solute transport under different testing conditions. Taken together, this work represents an important advancement in the fabrication of highly selective TFN membranes through precise control of interfacial chemistry and nanoscale structures in the filler-polyamide mixed matrix.

### Materials

Unless otherwise specified, reagents were of analytical grade and used as received without further purification. 1,4-Benzenedicarboxylic acid (H₂BDC, 99.0%), 2-amino-1,4-benzenedicarboxylic acid (H₂N—H₂BDC, 99.0%), chromium (III) nitrate nonahydrate (Cr(NO₃)₃·9H₂O, 99.0%), and sodium hydroxide (NaOH, 97.0%) ordered from Sigma-Aldrich were used for the syntheses of MOF nanoparticles. N,N-dimethylformamide (DMF, 99.8%) and methanol (MeOH, 99.9%) from VWR were used for MOF purification. Trimesoyl chloride (TMC, 98%), m-phenylenediamine (MPD, 99%), and sodium dodecyl sulfate (SDS, >99%) purchased from Sigma-Aldrich were used as the monomers and additive for the synthesis of the polyamide selective layer via interfacial polymerization. One polyethersulfone (PES) UF membrane from SOLETA was used as the porous substrate for the polyamide TFC and TEN membranes. (3-Glycidyloxypropyl)triethoxysilane (GPTES, ≥97%) was obtained from TCI for surface modification. Toluene (99.5%) and n-hexane (≥99.8%, SupraSolv® for GC-MS, distilled) were ordered from Sigma-Aldrich and Merck, respectively. Toluene and hexane were further dried with molecular sieves (4 Å, beads, 8-12 mesh, Sigma-Aldrich) for several days before use. Sodium chloride (NaCl, ≥99.5%, Sigma-Aldrich), sodium sulfate (Na₂SO₄, ≥99.0%, Acros Organics), magnesium sulfate (MgSO₄, 99.5%, Alfa Aesar), magnesium chloride (MgCl₂, ≥99.0%, Fisher Chemical), boric acid (H₃BO₃, 99.99%, Merck), and poly(ethylene glycol) with a molecular weight of 200 (PEG200, certified reference material, Sigma-Aldrich) were used as the probe solutes for membrane rejection tests. The boron standard for ICP analysis (VeriSpec, 10 g/L in H₂O) was supplied by Ricca Chemical. Dow SW30XLE desalination membrane was used as a commercial benchmark for comparison.

### MOF Synthesis and Purification

MIL-101 (Cr)—NH₂ MOF nanoparticles were synthesized via a base-assisted hydrothermal reaction following a known method. 252.1 mg Cr(NO₃)₃·9H₂O (0.63 mmol) and 115.9 mg H₂N—H₂BDC (0.64 mmol) were mixed in a 30 ml Teflon container. Then, 10 ml of 0.064 mol/L concentrated NaOH aqueous solution was added to the mixture. After being sonicated for 10 min, the container with the mixture was sealed in a Teflon-lined stainless-steel autoclave and heated at 140° C. for 24 h under autogenous pressure. The parent MIL-101 (Cr) nanoparticles were hydrothermally synthesized through an acid-free procedure as a benchmark. In a typical reaction, 132.1 mg Cr(NO₃)₃·9H₂O (0.33 mmol) and 54.8 mg H₂BDC (0.33 mmol) were mixed with 10 ml deionized water in a 30 ml Teflon container. After that, the mixture was sonicated for 1 h, and then heated to 180° C. in an autoclave for 4 h under autogenous pressure. After completion of each synthesis, the autoclave was allowed to naturally cool down to room temperature. The green solids were collected by centrifugation (11,000 rpm, 60-120 min) and then washed with DMF and MeOH three times each. The as-synthesized MOF particles were dispersed and stored in MeOH for further characterization and testing.

The parent MIL-101 (Cr) nanoparticles were hydrothermally synthesized through an acid-free procedure as a benchmark for comparison. After completion of each synthesis, the green solids were collected by centrifugation and then washed with DMF and MeOH three times each.

### Post-Synthetic Modifications of MIL-101 (Cr)—NH₂

Acid chlorides and amines have some of the highest reaction rate constants of known step polymerization reactions. These reactions form the basis for interfacial polymerization of polyamides, but trimesoyl chloride (TMC) can likewise react with the amines on MIL-101 (Cr)—NH₂. As such, TMC was reacted with the amines on the MIL-101 (Cr)—NH₂ framework in anhydrous hexane at room temperature for 12 hours to form amide bonds between the carbonyl chloride and amine groups. In a typical reaction, the as-synthesized MIL-101 (Cr)—NH₂ particle suspension in MeOH was solvent exchanged with hexane three times by centrifugation. Then, the particles were redispersed in 30 ml anhydrous hexane under strong sonication. After that, 0.265 g (1.0 mmol) TMC was added into the suspension containing around 0.2 g MIL-101 (Cr)—NH₂ nanoparticles. The resulted mixture was reacted for 12 hours at room temperature under strong shaking. After completion of the reaction, the TMC modified MIL-101 (Cr)—NH₂ nanoparticles (i.e., TMC@MIL-101 (Cr)—NH₂) were collected by centrifugation and then washed with hexane three times.

GPTES modification of the MOF surface was accomplished in anhydrous toluene at 110° C. for 24 h via an epoxide ring-opening reaction with the amine groups on MIL-101 (Cr)—NH₂. More specifically, about 0.2 g MIL-101 (Cr)—NH₂ nanoparticles were dispersed in anhydrous toluene three times via solvent exchange and probe sonication. The MIL-101 (Cr)—NH₂ suspension was then transferred into a 250 ml three-neck round bottom flask equipped with an air reflux condenser connected to a nitrogen feed on a Schlenk line. A certain amount of toluene was subsequently added to increase the total volume of the reaction mixture to 50 ml. After that, 153.1 mg (0.55 mmol) GPTES was added into the flask dropwise with a precision pipette under stirring and nitrogen protection. The equivalent of GPTES relative to the amine groups of MIL-101 (Cr)—NH₂ was kept at 0.8. The reaction mixture was then heated to 110° C. and reacted at this temperature for 24 hours with nitrogen protection under vigorous stirring (i.e., 800 rpm). When the reaction was complete, a slight change in color from green to yellowish was observed for the GPTES modified MIL-101 (Cr)—NH₂ (i.e., GPTES@MIL-101 (Cr)—NH₂) nanoparticles. The solid particles were collected by centrifugation and then washed with toluene three times. MIL-101 (Cr)—NH₂ nanoparticles modified by GPTES and then TMC were named as TMC@GPTES@MIL-101 (Cr)—NH₂. The obtained MOF nanoparticles were redispersed in methanol or hexane by probe sonication for further characterization and membrane fabrication.

For this sample, GPTES stabilizes the filler suspension in hexane and reduces particle agglomeration, whereas TMC induces an in situ chemical crosslinking of MOFs with the polyamide to enhance phase compatibility and thus eliminate interfacial defects. The specific experimental procedures and reaction parameters for all the modifications are further described below. The obtained nanoparticles were redispersed in methanol or hexane by probe sonication for further characterization and membrane fabrication.

### Fabrication of Polyamide TFC and TFN Membranes

The TFC benchmark membrane was prepared by synthesizing a polyamide selective layer on a PES porous substrate through the interfacial polymerization of m-phenylenediamine (MPD) and TMC in the presence of sodium dodecyl sulfate (SDS). First, the PES substrate was immersed in an aqueous solution of 2.0 wt % MPD in the presence of 0.1 wt % SDS for 2 min. After removing the excess water on the top surface using filter paper and a rubber roller, the MPD saturated substrate was sandwiched into a lab-made frame with the top skin layer facing upwards. The interfacial polymerization was completed by carefully adding enough solution of 0.2 wt % TMC hexane solution into the frame to cover the surface of the substrate, which was allowed to react with the MPD for 1 min. When the reaction was complete, the excess hexane solution was drained, and the resulting membrane was dried in air at ambient condition for 3 hours.

TFN membranes were fabricated following the same procedure as the TFC benchmark, but while also adding MOF nanoparticles in the 0.2 wt % TMC/hexane monomer solution. Nanoparticle dispersions were prepared by probe sonication for 15 seconds immediately before interfacial polymerization. The content of MOF nanoparticles in the hexane solution varied from 0.04-0.5 wt %, depending on the stability of the particle suspension. The resulting TFN membranes made from TMC@MIL-101 (Cr)—NH₂ and TMC@GPTES@MIL-101 (Cr)—NH₂ nanoparticles were denoted as TFN(X) and TFNg(X), respectively, where X represents the particle loading in the hexane solution. TFN membranes with different amounts of MIL-101 (Cr) benchmark particles were also prepared using the same procedure for comparison. All the as-synthesized TFC and TFN membranes were stored in deionized water at 5° C. prior to characterization and performance tests.

### Characterization

Powder X-ray diffraction (XRD) measurements were conducted on a Rigaku Smartlab Multipurpose diffractometer equipped with a Cu tube (2=1.5406 Å) and a VANTEC-500 2D detector at a voltage of 45 kV and 200 mA. Transmission electron microscope (TEM) images were taken on an FEI Tecnai (G2 Spirit TWIN) multipurpose digital system operating at 120 kV. A Zeiss Merlin high-resolution scanning electron microscope (SEM) was used for particle and membrane morphological analysis. The XRD patterns were collected over an angular range of 2-40° (2θ) with a step size of 0.1° at ambient conditions.

The Fourier-transform infrared (FT-IR) spectra were acquired on an Alpha II Fourier transform infrared spectrometer (FTIR6700, Bruker) in attenuated total reflection (ATR) mode. Each sample was measured for a total of 32 scans with a resolution of 4 cm⁻¹ in the spectral range of 400-4000 cm⁻¹.

Elemental and chemical spectroscopic analysis was determined by X-ray photoelectron spectroscopy (XPS) using a ULVAC-PHI Versaprobe II instrument with a monochromic Al-Kα X-ray source (hv=1486.6 eV). The X-ray source power was 50 W and the beam spot size was 200 μm. Thermogravimetric analysis (TGA) was performed on a TA Instruments 550 thermogravimetric analyzer in an air atmosphere. In a typical measurement, the sample was heated under N₂ to 100° C. with a heating rate of 10° C./min followed by a constant temperature interval for 1 h to remove the moisture present in the sample. The temperature was then allowed to equilibrate to 40° C. and once it stabilized, the gas was switched to air and the sample was heated to 1000° C. at 10° C./min.

Thermogravimetric analysis (TGA) was performed on a TA Instruments 550 thermogravimetric analyzer in an air atmosphere.

Water contact angles were collected with the sessile drop method on a Contact Angle Goniometer (Rame Hart, USA) using deionized water as the probe liquid. Powder samples were pressed into tablets using a press machine and the membrane samples were freeze dried overnight before measurements. At least ten readings were taken at random locations for each membrane sample and the averaged value was reported.

The surface zeta potential at a pH value of 7.0 of the MOF nanoparticles was measured by a NanoBrook Series size and zeta potential analyzers (Brookhaven Instruments) at 23° C. The particles were dispersed in deionized water with ultralow sample loading, and the suspension was highly diluted and sonicated for 10 min right before the measurements.

The N₂ adsorption-desorption isotherms and pore size distribution were measured on a Micromeritics 3Flex apparatus at 77 K. The Brunauer-Emmett-Teller (BET) and Langmuir surface areas were calculated over a range of relative pressures between 0.05 and 0.20.

Transmission electron microscope (TEM) images were taken on an FEI Tecnai (G2 Spirit TWIN) multipurpose digital system operating at 120 kV. In a typical sample preparation, a few drops of the highly-diluted and well-dispersed particle suspension in a volatile solvent was drop-cast on a lacey carbon-coated 200 mesh copper grid (Electron Microscopy Sciences). The particle size distribution was obtained from TEM images under high magnification. A Zeiss Merlin high-resolution scanning electron microscope (SEM) was used for particle and membrane morphological analysis. SEM samples were thoroughly dried under vacuum and then sputter-coated with gold/palladium alloy using a Desk II cold sputter unit (Denton Vacuum LLC).

### Water Separation Performance Tests

Water separation performance of the developed TFN membranes were characterized under RO mode at 23° C. using a Sterlitech HP4750 high-pressure stirred cell with an effective membrane area of 14.6 cm². Before collecting data, each membrane sample was conditioned at 150 psi for at least 2 hours. Pure water permeability (PWP) or water permeance (A, L m⁻² h⁻¹ bar⁻¹) was then measured at various pressures using deionized water as the feed, and the value of A was calculated as:

$$A = \frac{{J}_{w}}{Δ P} = \frac{Δ V}{S Δ t Δ P} \qquad ( 1 )$$

where J_{w} (L m⁻² h⁻¹) is the water flux at the permeate side, ΔP (bar) is the trans-membrane hydraulic pressure, S (m²) is the effective membrane surface area, and ΔV (L) is the volume of permeate collected during a time interval of Δt (h). Next, membrane rejection tests were performed under various testing conditions by using different types of solutes. More specifically, NaCl, Na₂SO₄, MgCl₂, and MgSO₄ solutions with different concentrations were used as the probe feed for measuring membrane rejections to inorganic salts, while 200 ppm PEG200 solution and a 5 ppm boric acid solution at a pH value of 7.5 were applied to determine membrane rejections toward small neutral contaminants. For each test, the membrane rejection R (%) was calculated as

$$R ( \% ) = ( 1 - \frac{{C}_{p}}{{C}_{f}} ) \times 100 \qquad ( 2 )$$

where Cₚ and C_{f} are the solute concentrations of the permeate and feed solution, respectively. The salt concentration in the permeate and feed was obtained by conductivity measurement using a SevenCompact™ S230 (Mettler Toledo) conductivity meter. The PEG200 and boric acid contents in the permeate and feed solution were measured by a Total Carbon Analyzer (TOC, Multi N/C 3100, Analytik Jena, Germany) and Inductively Coupled Plasma-Optical Emission Spectrometer (ICP-OES, Agilent ICP-OES 5100 VDV), respectively. The solute permeability coefficient (B, L m⁻² h⁻¹) was then estimated by the following equation.

$$B = ( \frac{100 \%}{R} - 1 ) \times {J}_{w} \qquad ( 3 )$$

### Results

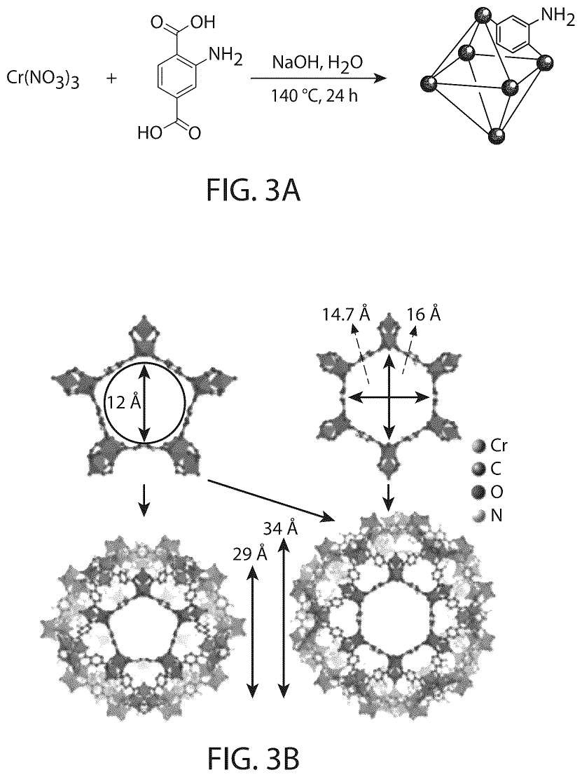

MIL-101 (Cr)—NH₂, an amine-functionalized mesoporous MOF consisting of trimeric Cr³⁺ octahedral clusters linked by H₂N—H₂BDC, was directly synthesized via a NaOH-assisted hydrothermal reaction (FIG. 3A). Its large interconnected void spaces increase diffusivity by providing high free volume, while the accessible amine (—NH₂) moiety enables post-synthetic modifications through which the pore aperture size and chemistry could be finely tuned (FIG. 3B). Since the polyamide selective layer formed via interfacial polymerization is often less than a hundred nanometers thick, the size of the filler particles must be correspondingly small so that they can be accommodated within the selective layer. TEM and SEM images showed that the as-synthesized MIL-101 (Cr)—NH₂ particles had an averaged particle size of ˜25 nm in diameter with a narrow particle size distribution. The obtained particle sizes of less than 40 nm is among the smallest of all reported MIL-101 (Cr)—NH₂ MOFs, making them of particular interest for preparing polyamide TFN membranes.

The parent MIL-101 (Cr) MOF that possesses the same crystalline structure, but without the presence of amine groups, was synthesized for comparison. The as-synthesized MIL-101 (Cr) nanoparticles showed the typical octahedral morphology with small particle sizes of less than 80 nm in diameter.

Powder XRD patterns in confirmed the crystal structures of the MIL-101 (Cr)—NH₂ and MIL-101 (Cr) MOF nanoparticles. The estimated crystallite size based on the Scherrer equation is approximately 20 nm for MIL-101 (Cr)—NH₂, which is consistent with the observations from the SEM and TEM images.

The chemical identities of the MIL-101 (Cr)—NH₂ and MIL-101 (Cr) nanoparticles were confirmed by FT-IR and XPS. Consistent with the IR spectral features reported in the literature, the —N—H asymmetric and symmetric vibrations were observed in MIL-101 (Cr)—NH₂ at 3390 cm-1 and 3380 cm⁻¹, while the peaks at 1593 cm⁻¹ and 1340 cm⁻¹ are ascribed to the —N—H bending vibration and the —C—NH₂ stretching off the phenyl ring. XPS elemental analysis also shows the N 1s peak at 399.2 eV in MIL-101 (Cr)—NH₂, and the N/Cr atomic ratio is almost the same as the theoretical value (i.e., 1.0). TGA analysis showed that MIL-101 (Cr)—NH₂ has a larger weight loss at high temperatures than the MIL-101 (Cr) benchmark due to the presence of the amine functional groups. It was also observed that the two MOFs have the same type of N₂ adsorption-desorption isotherm because of their isostructural topology. MIL-101 (Cr)—NH₂ had a high BET surface area of 2800 m² g⁻¹ and Langmuir surface area of 4100 m² g⁻¹, which are slightly lower than those of the MIL-101 (Cr) benchmark possibly due to the partial pore blockage by the amine groups in the framework. Three prominent pores centered at approximately 11, 23, and 31 Å were observed in the pore size distribution curves of both MOFs, matching with their mesoporous crystalline structure. In addition, both MOFs showed hydrophilicity and positively charged surfaces at a pH value of 7.0 in water (Table 1).

TABLE 1
Physiochemical properties of the pristine and modified MIL-
101(Cr)—NH₂ nanoparticles and the MIL-101(Cr) benchmark.

| | BET | Langmuir | | | |
|---|---|---|---|---|---|
| | surface | surface | Particle | | |
| Sample | area | area | size | ζ | θ_{w} |
| ID | (m² g⁻¹) | (m² g⁻¹) | (nm) | (mV) | (°) |
| MIL-101(Cr) | 3000 | 4400 | <80 nm | 25.6 | Complete |
| | | | | | wetting |
| MIL-101(Cr)—NH₂ | 2800 | 4100 | <40 nm | 44.3 | Complete |
| | | | | | wetting |
| TMC@MIL- | 1100 | 1600 | <40 nm | 17.6 | Complete |
| 101(Cr)—NH₂ | | | | | wetting |
| GPTES@MIL- | 1000 | 1200 | <40 nm | 28.9 | Complete |
| 101(Cr)—NH₂ | | | | | wetting |
| TMC@GPTES@MIL- | 610 | 750 | <40 nm | 21.5 | Complete |
| 101(Cr)—NH₂ | | | | | wetting |

Surface areas were calculated in the P/P₀ range of 0.05-0.2; particle size was obtained from TEM images; Zeta potential (ζ) was measured in pure water at a pH of 7.0.

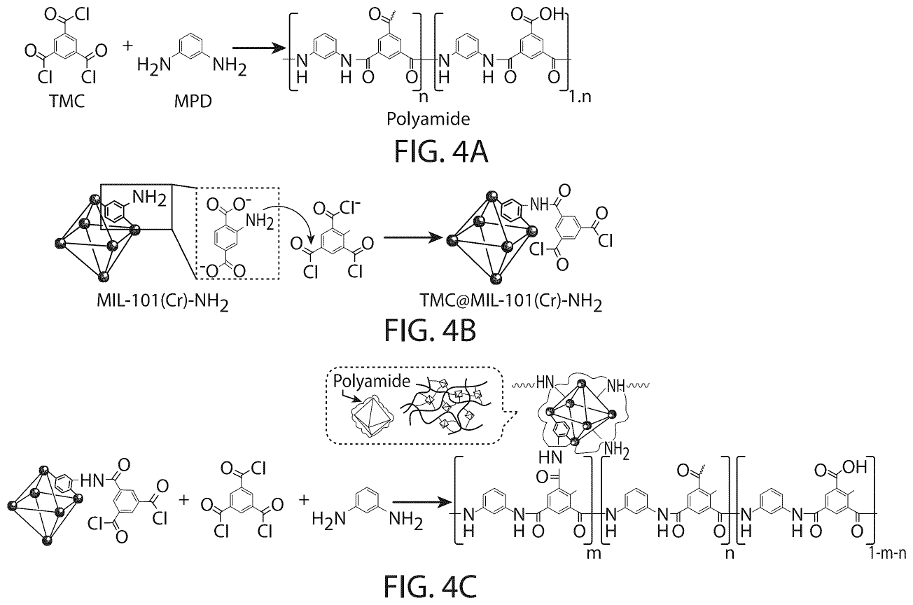

The polyamide selective thin film of the TFC membrane is typically formed via an interfacial polymerization reaction between MPD and TMC (FIG. 4A). To enhance the compatibility and interactions of the fillers with polyamide, an in situ chemical crosslinking reaction between the MIL-101 (Cr)—NH₂ fillers and the polyamide was employed. The MIL-101 (Cr)—NH₂ nanoparticles were modified by TMC before interfacial polymerization, where the acid chloride group on TMC reacted with the amine (—NH₂) group on MIL-101 (Cr)—NH₂ forming an amide bond (FIG. 4B). The unreacted acid chlorides remain accessible for subsequent crosslinking reactions with MPD monomers for the formation of polyamide (FIG. 4C). As a result, the functionalized MIL-101 (Cr)—NH₂ could be uniformly incorporated into the polyamide layer through robust chemical linkages, thus improving phase compatibility.

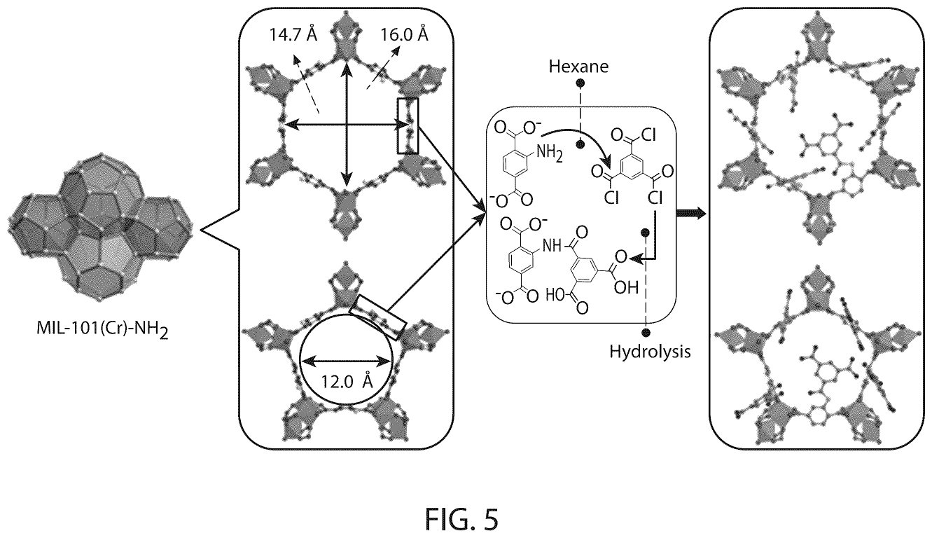

In addition, TMC modification provides a valuable platform to tune the pore aperture and chemistry of the MIL-101 (Cr)—NH₂ fillers through a path presented in FIG. 5. While the bare framework has pores that are too large for effective size exclusion of conventional inorganic salts (Table 2), post-synthetic modification reduces the pore aperture size of the MIL-101 (Cr)—NH₂ fillers, constricting pores to dimensions more favourable for size sieving. As shown in FIG. 5, the TMC molecules are small enough that they can readily diffuse into the MOF framework and react with the amine groups during TMC modification. As an additional benefit, a large number of carboxylic acid groups will be formed in the framework upon the hydrolysis of the incorporated TMC. In the context of water separations, the resulting hydrophilic nanochannels with small pore windows and negative charges in the TMC@MIL-101 (Cr)—NH₂ fillers would provide effective molecular sieving selectivity and preferential water permeability.

TABLE 2
Ionic diameters, hydrated ionic diameters, and Gibbs free energies
for the ions that are normally found in brine water.

| | | | Gibbs free |
|---|---|---|---|
| | Ionic | Hydrated | energy of |
| | diameter | diameter | hydration |
| Ion | (Å) | (Å) | (kJ mol⁻¹) |
| Na⁺ | 1.90 | 7.16 | −365 |
| Mg²⁺ | 1.30 | 8.80 | −1830 |
| Ca²⁺ | 1.98 | 8.40 | −1505 |
| Li⁺ | 1.38 | 7.64 | −475 |
| Cl⁻ | 3.62 | 6.64 | −340 |
| SO₄²⁻ | 4.60 | 7.58 | −1080 |
| HCO₃⁻ | 3.12 | 8.78 | −335 |
| NO₃⁻ | 3.58 | 6.80 | −300 |

Powder XRD and TEM imaging indicated that TMC modification shows negligible changes in crystallinity, particle size, and morphology of MIL-101 (Cr)—NH₂ due to its excellent chemical stability. Successful grafting of TMC on MIL-101 (Cr)—NH₂ was confirmed by the FT-IR and XPS spectra. TMC@MIL-101 (Cr)—NH₂ nanoparticles displayed the characteristic C═O and C—N stretch absorbance peaks in the IR spectra at 1710 cm⁻¹ and 1020 cm⁻¹, respectively, while the broad peak at 3000 cm⁻¹ is assigned to the vibration of the C—H bonds on the benzene ring of TMC. The appearance of a chlorine peak in the XPS spectra of TMC@MIL-101 (Cr)—NH₂ also confirmed the presence of TMC on the framework. TGA analysis showed a 7.2 wt % increase in weight loss for TMC@MIL-101 (Cr) at high temperatures compared to the pristine MIL-101 (Cr)—NH₂. This percentage corresponds to approximately 20.0% of the amine groups on the MOF reacting with TMC during modification. Consistent with the physical picture of pore blockage in FIG. 5, the BET surface area of the TMC@MIL-101 (Cr) nanoparticles decreased from 2800 to 1100 m² g⁻¹ with a concomitant reduction in pore aperture size and pore volume, where the smaller and larger pore sizes decreased to ˜6.5 Å and ˜25 Å, respectively. Importantly, the small pore size is larger than the effective diameter of H₂O (˜2.8 Å) but smaller than the effective diameters of many hydrated ions such as Na+ (7.16 Å), Cl (6.64 Å), and Mg²⁺ (8.80 Å) (Table 2). As fillers in TFN membranes, the resulting hierarchical pore structure of TMC@MIL-101 (Cr)—NH₂ can enhance diffusion selectivity through molecular sieving, while simultaneously improving water permeability. After following the same procedure, TMC modification was not observed in the parent MIL-101 (Cr) benchmark, suggesting that incorporation of TMC on MIL-101 (Cr)—NH₂ occurs through chemical grafting rather than through physical adsorption. A significant decrease in Zeta potential, from 44.3 mV to 17.6 mV (Table 1), was also observed for TMC@MIL-101 (Cr)—NH₂, supporting the assertion of the presence of many carboxylic acids in the framework. As depicted in FIG. 5, these carboxylic acids groups originated from the hydrolysis of the grafted TMC molecules.

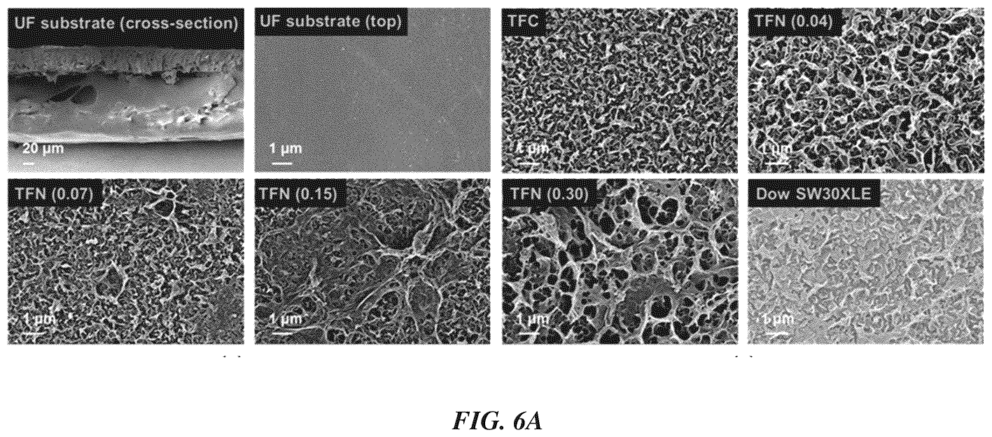

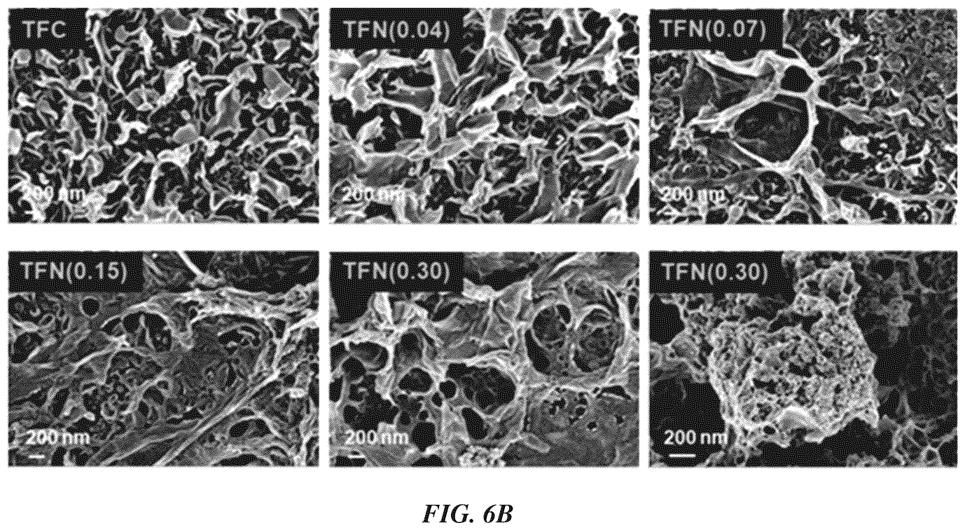

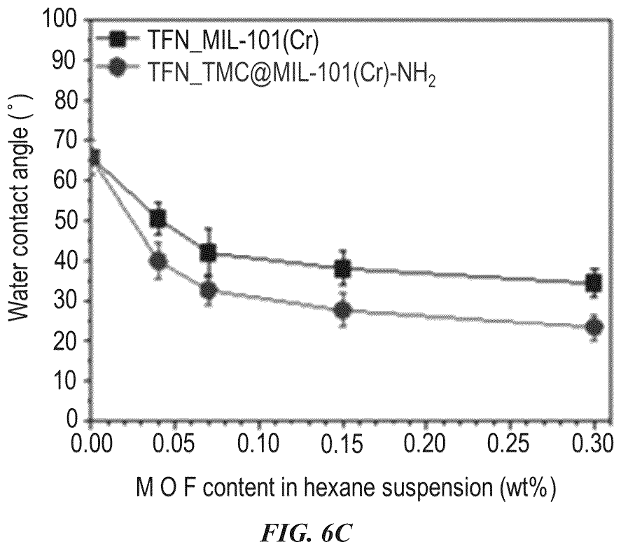

FIG. 6A shows the SEM morphology of the PES substrate, the TFN membranes with different TMC@MIL-101 (Cr)—NH₂ particle loadings, and the Dow SW30XLE TFC benchmark membrane. The PES substrate was a UF membrane with a porous cross-section structure and a smooth top surface. It showed a high water permeance greater than 110 L m⁻² h⁻¹ bar⁻¹ and negligible rejection to NaCl. The polyamide TFC control membrane showed the typical “ridge-and-valley” surface morphology, which is like that of the Dow SW30XLE membrane and other polyamide TFC membranes. Interestingly, the addition of TMC@MIL-101 (Cr)—NH₂ nanoparticles changes the morphology of the polyamide layer. As shown in FIG. 6A and FIG. 6B, a significant increase in the size of the “ridge” structure was observed for the TEN membranes and the difference becomes more pronounced as particle loading increased. XPS data and XRD patterns confirmed the successful incorporation of the TMC@MIL-101 (Cr)—NH₂ fillers into the polyamide layer, where particle loading increases with MOF content in hexane. Compared to the TFN control membranes formed with MIL-101 (Cr), the TMC@MIL-101 (Cr)—NH₂ TFN membrane showed a higher filler loading at the same particle content in hexane suspension, suggesting that the TMC-induced in situ crosslinking prompts the incorporation of the fillers in the polyamide layer. The carboxylate-based MIL-101 (Cr)—NH₂ MOF had a higher content of oxygen and a higher O/N ratio relative to the polyamide, providing an opportunity to access the influence of MOF fillers on the chemical structure of the polyamide phase. The TEN control membranes with MIL-101 (Cr) showed a monotonic increase in the O/N atomic ratio with the increase of MOF loading. These ratios are even higher than that of a fully linearly crosslinked polyamide (i.e., 2.0). In contrast, a slight drop in the O/N ratio was observed for the TFN (0.04) and TFN (0.07) membranes at low TMC@MIL-101 (Cr)—NH₂ loadings. This contrasting finding suggests that the functionalized MIL is important for cross-linking with the polyamide phase, supporting FIG. 3. Moreover, cross-linking of polyamide phase increased with the presence of the MOF fillers during interfacial polymerization. In addition to the chemical interaction between polyamide and TMC@MIL-101 (Cr)—NH₂ fillers, the hydrophilic MOF fillers with high porosity can prompt the diffusion of MPD monomers into the hexane phase, which promotes the interfacial crosslinking reaction. Furthermore, the heat released from the hydration of MOF fillers and removal of the HCl by-product by amine groups on the framework during interfacial polymerization likely alters the chemical structure of the polyamide. Water contact angle measurements in FIG. 6C indicate that the incorporation of the MOF fillers dramatically improved the hydrophilicity of the TFN membranes.

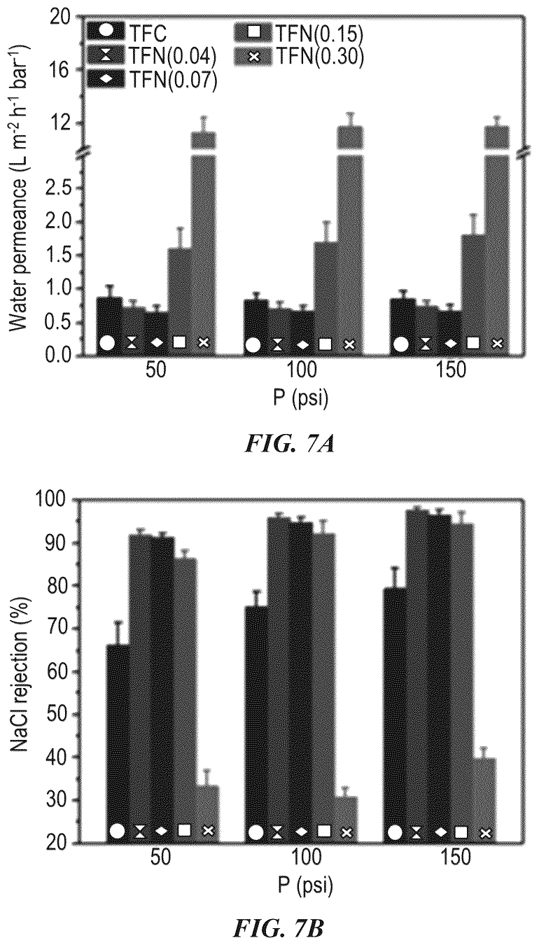

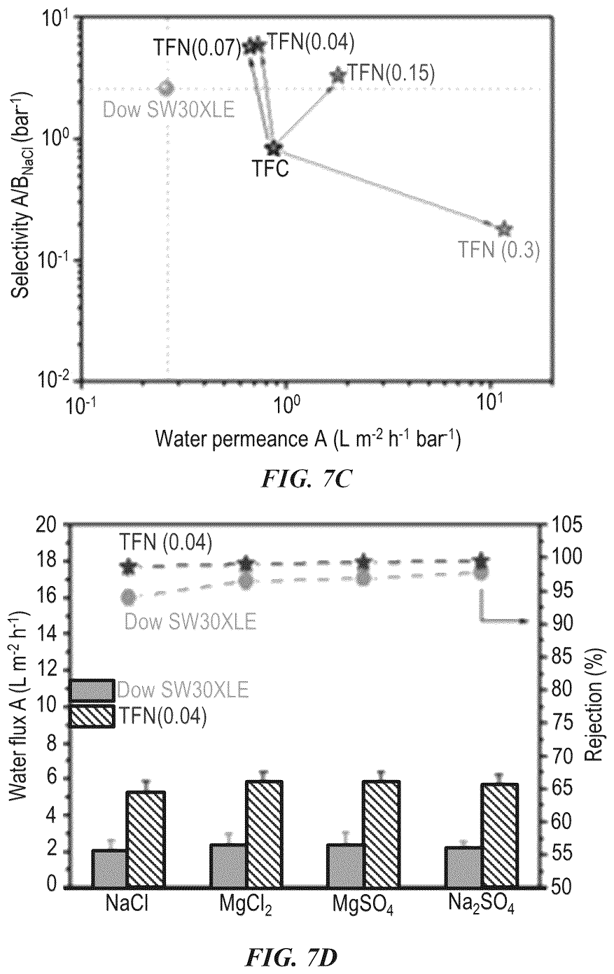

After the initial physical and chemical characterization, the water filtration performance of the TFN membranes was examined at different testing conditions. As presented in FIG. 7A, the TFC benchmark membrane has a water permeance of 0.85 L m⁻² h⁻¹ bar⁻¹ with a NaCl rejection of 79.3% at 150 psi. The incorporation of the TMC@MIL-101 (Cr)—NH₂ fillers caused a slight drop in water permeance, where the water permeance of the TFN (0.04) and TFN (0.07) membranes decreased to 0.73 and 0.67 L m⁻² h⁻¹ bar⁻¹, respectively. Conversely, a dramatic boost in NaCl rejection was achieved by the TFN membranes, where a high rejection of 98.0% and 97.0% were obtained by the TFN (0.04) and TFN (0.07) membranes at 150 psi (FIG. 7B), indicative of a defect-free packing structure of the formed polyamide-filler composite. Such results match the hypotheses proposed in FIGS. 4A-4C and FIG. 5 but are contradictory to the typical results obtained upon incorporating particles into the polyamide selective layer, where traditional TFN membranes show a significant increase in water permeance with a decrease in rejection. In this work, the increase in salt rejection can be ascribed to the molecular sieving effects induced by the small pore size of the TMC@MIL-101 (Cr) fillers (FIG. 5), densification of polyamide around the filler particles, and elimination of interfacial defects by in situ crosslinking (FIGS. 4A-4C). These three factors allow the MOF fillers to enhance molecule transport across the membrane by acting as preferential flow paths for water transport. The slightly lowered water permeance is possibly due to a concomitant reduction in polymer chain flexibility at the polyamide-filler interface. The visible changes in morphology and microstructure of the polyamide phase may also result in a substantial reduction in the water transport rate. FIG. 7C further shows that TFN membranes with a filler content of less than 0.15 wt % exhibit a higher water permeance and water/NaCl selectivity compared to the Dow SW30XLE commercial benchmark. In particular, the most selective TFN (0.04) membrane shows excellent rejections to many other inorganic salts such as MgCl₂ (98.6%), MgSO₄ (99.1%), and Na₂SO₄ (99.5%) with high water flux of 5.6-6.0 L m⁻² h⁻¹ at 150 psi (FIG. 7D), which is 2.5 times higher than that of the commercial benchmark. When the MOF content is increased to 0.15 wt %, the water permeance of the TFN (0.15) membrane increases to 1.8 L m⁻² h⁻¹ bar⁻¹, while the NaCl rejection slightly drops to 95.0% at 150 psi.

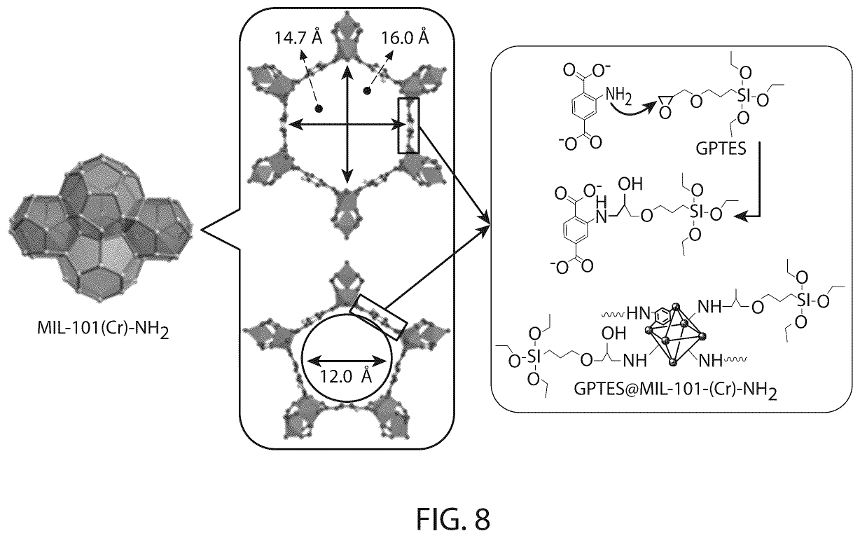

Unfortunately, near the limit of filler loading, NaCl rejection decreases substantially. The TFN (0.3) membrane, which was formed from a 0.3 wt % MOF/hexane suspension had an NaCl rejection of 39.7% at 150 psi, while the water permeance dramatically increased to 11.7 L m 2 h⁻¹ bar⁻¹ (FIGS. 7A and 7B). Deterioration in membrane selectivity at high filler loadings was likely associated with non-selective voids from particle agglomeration in the polyamide thin layer. Due to their high surface energy, the hydrophilic MIL-101 (Cr)—NH₂ nanoparticles are prone to agglomerate in hexane even at relatively low particle loadings. Large particle agglomerates are likely to form non-selective voids between the filler particles, and these effects become more pronounced for very thin films like those considered in this study. To address this limitation, a second approach was considered for filler particle preparation. In this case, the MIL-101 (Cr)—NH₂ particles were post-synthetically modified with GPTES, which has good affinity with hexane. As depicted in FIG. 8, GPTES molecules were chemically grafted onto MIL-101 (Cr)—NH₂ nanoparticles through an epoxide ring-opening reaction. The presence of GPTES on MIL-101 (Cr)—NH₂ nanoparticles could lower their surface energy and stabilize the particle suspension in hexane, suppressing the formation of particle agglomerations and thus increasing the filler loading in the TFN membranes without causing non-selective voids. At the same time, depending on GPTES surface coverage, this approach would limit MOF-polyamide crosslinking during interfacial polymerization, thus providing additional details on loading limits and separation performance as they relate to chemical versus physical incorporation of MOF particles.

GPTES modification of the MIL-101 (Cr)—NH₂ was chemically and physically characterized through a host of techniques. The emerging Si—O vibration peak at 1050 cm⁻¹ in the FT-IR spectra and the appearance of the Si signal at 100 eV in the XPS spectra confirmed successful grafting of GPTES onto MIL-101 (Cr)—NH₂. The appearance of a new weight-loss feature beginning at 200° C. in the TGA curve of GPTES@MIL-101 (Cr)—NH₂ further confirmed the presence of GPTES in the framework. Powder XRD patterns and TEM images indicate that GPTES modification had no changes in particle crystallinity and morphology compared to the unmodified particles. Like the TMC modification, the BET surface area of the GPTES@MIL-101 (Cr)—NH₂ nanoparticles dropped to 1000 m² g⁻¹ with a salient decrease in pore aperture size. Notably, the GPTES@MIL-101 (Cr)—NH₂ nanoparticles exhibited significantly improved dispersibility in hexane, where the unmodified particles aggregated and precipitated within 1 min of ultrasonication. Furthermore, the TMC chemical modification was also applied to the GPTES@MIL-101 (Cr)—NH₂ nanoparticles, as confirmed by the FT-IR data and TGA data. Importantly, the smallest pore size of TMC@GPTES@MIL-101 (Cr)—NH₂ decreased to around 6 Å. These sub-nanometer pores may behave like water channels to facilitate water permeation while blocking hydrated ions and other contaminants.

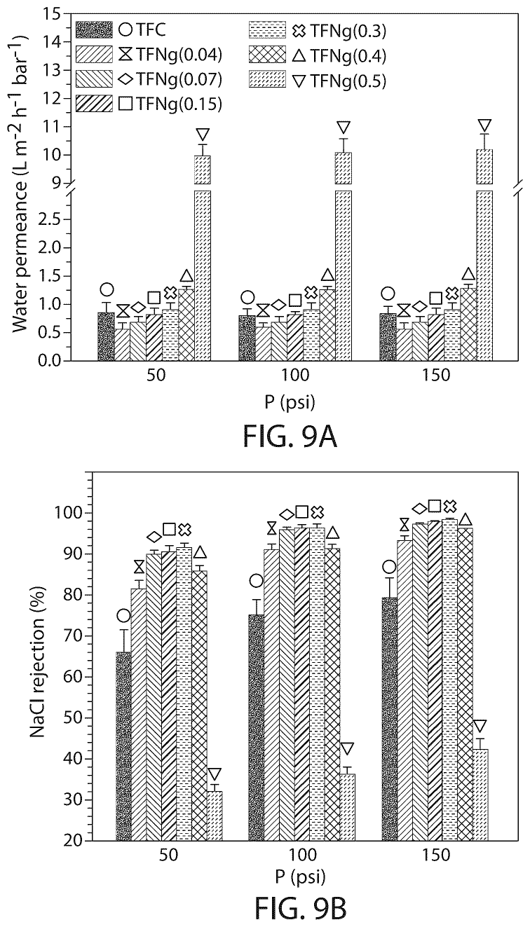

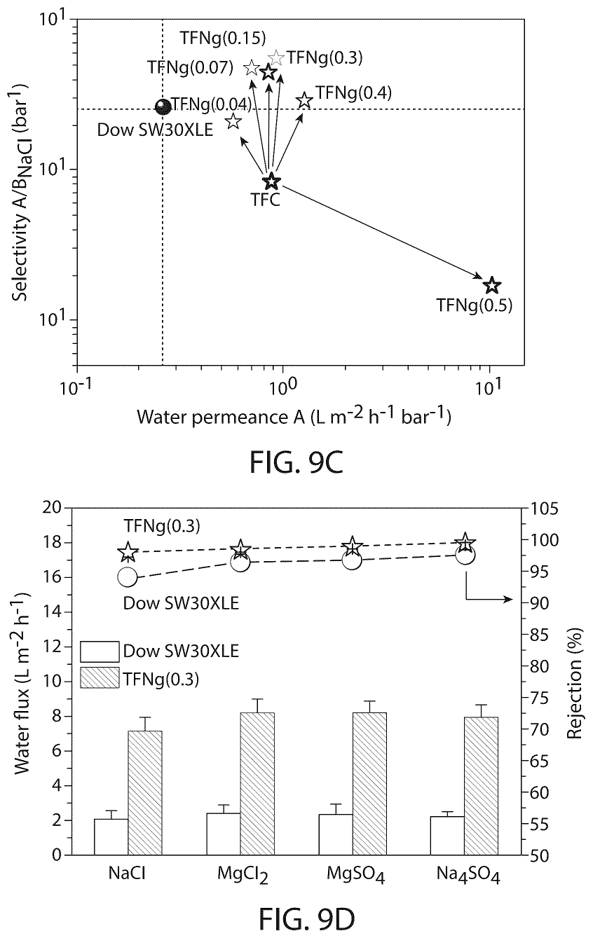

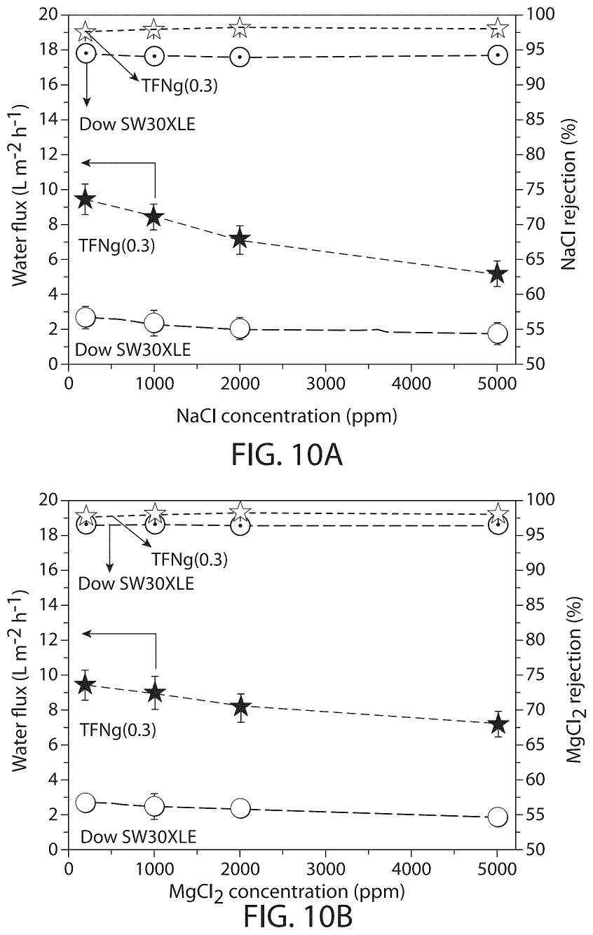

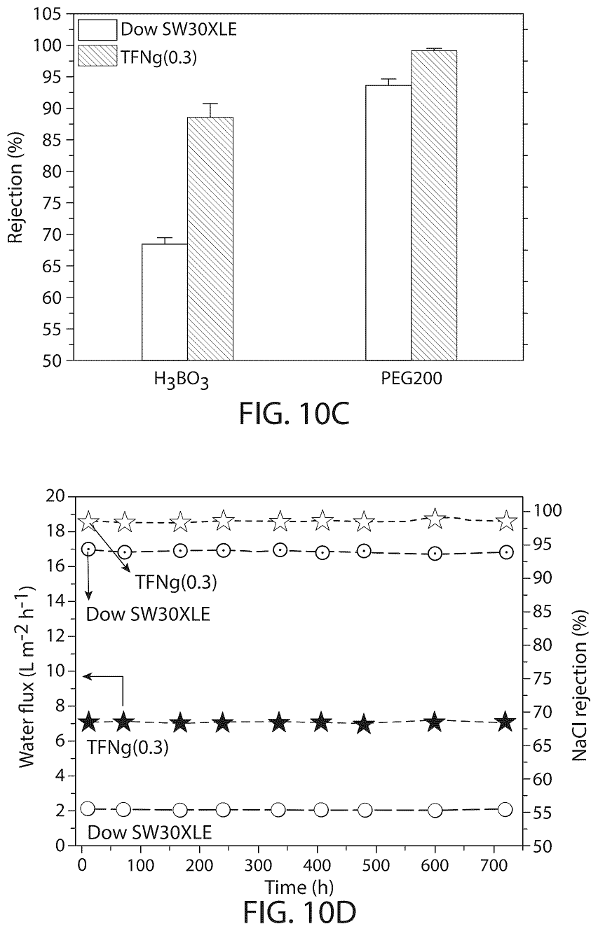

Using the TMC@GPTES@MIL-101 (Cr)—NH₂ nanoparticles, a series of new polyamide TFN membranes with different particle loadings were fabricated. FIGS. 9A-9B show the water permeance and NaCl rejections of the resulting TFNg membranes at 50, 100, and 150 psi. Like the observations in FIGS. 7A-7D, the addition of TMC@GPTES@MIL-101 (Cr)—NH₂ nanoparticles results in a slight decrease in water permeance but a remarkable increase in NaCl rejection compared to the TFC benchmark. With the increase of particle loading, however, both water permeance and rejection continue to increase until the particle content in hexane suspension reaches a high value of 0.4 wt %. The TFNg (0.3) membrane showed a high NaCl rejection of 98.5% with a water permeance of 0.9 L m⁻² h⁻¹ bar⁻¹ and the TFNg (0.4) membrane shows a high water permeance of 1.3 L m⁻² h⁻¹ bar⁻¹ with an NaCl rejection of 96.1% at 150 psi, outperforming the TFC benchmark. Examples of polyamide TFN membranes with such high particle loadings and minimal defects are exceedingly rare in the open literature. Compared to the TFN membranes prepared with TMC@MIL-101 (Cr)—NH₂ nanoparticles, the TFNg membrane showed both higher water permeance and NaCl rejection at each loading, likely due to the increased filler loading in the polyamide layer. These results demonstrate that GPTES modification is an effective method to reduce particle agglomerations by tuning filler surface chemistry. FIG. 9C further shows that TFNg membranes with a particle content of less than 0.4 wt % have higher water permeance and water/NaCl selectivity compared to the Dow SW30XLE commercial benchmark. In addition to NaCl, the TFNg (0.3) membrane shows high rejections of larger than 99.0% to MgCl₂, Na₂SO₄, and MgSO₄ salts with a water flux larger than 8.0 L m⁻² h⁻¹ at 150 psi (FIG. 9D). This flux is about four times higher than that of the SW30XLE benchmark, while the rejection also surpasses the respective value obtained by the benchmark under the same conditions. Furthermore, the TFNg (0.3) membrane maintains its high water flux and rejection to NaCl and MgCl₂ in a wide range of salt feed concentrations (FIGS. 10A-10B).

This size-selective behavior was also observed for small neutral contaminants. As displayed in FIG. 10C, rejections of 99.2% and 89.0% to PEG200 and boric acid at a pH value of 7.5 were achieved by the TFNg (0.3) membrane at a testing pressure of 150 psi. Conversely, the SW30XLE benchmark showed a lower rejection of 94.0% and 69.0% toward each solute under the same testing conditions. The persistently high rejections to boric acid and PEG200 imply that GPTES modification and TMC in situ crosslinking create a defect-free structure in the TFNg membranes even at high filler loadings. The subnanometer pores of the TMC@GPTES@MIL-101 (Cr)—NH₂ nanoparticles embedded in the polyamide thin film successfully induce molecular sieving (Table 3). The structural stability of the TFN membranes was confirmed through long-term performance tests shown in FIG. 10D. Compared to other TFN membranes reported in the literature, the newly developed TFN membranes display much more significant improvements in water permeance and rejection when compared to the respective TFC benchmark. These results demonstrate that post-synthetic modification and in situ crosslinking between fillers and polyamide are effective methods for the formation of defect-free polyamide thin-film nanocomposites with high filler loadings.

TABLE 3
Pure water permeance (A) and water/solute selectivity
(A/B) for various solutes of the developed TFNg(0.3)
membrane and Dow SW30XLE benchmark.

| Sample | A | A/B_{NaCl} | A/B_{MgCl2} | A/B_{H3BO3} | A/B_{PEG200} |
|---|---|---|---|---|---|
| ID | (LMH/bar) | (bar⁻¹) | (bar⁻¹) | (bar⁻¹) | (bar⁻¹) |
| TFNg(0.3) | 0.91 | 6.5 | 11.5 | 0.97 | 11.9 |
| Dow | 0.26 | 2.4 | 3.5 | 0.21 | 1.4 |
| SW30XLE | | | | | |

Table legend: A = water permeability; B = solute permeability; NaCl, MgCl₂, H₃BO₃, and PEG200 are the solutes for rejection tests.

### Conclusions

A facile and effective method was successfully developed to fabricate highly selective and permeable polyamide TFN membranes with high particle loadings. To address the phase compatibility and interfacial issues between fillers and polyamide, MIL-101 (Cr)—NH₂ filler particles were modified by TMC, where one acid chloride of TMC reacted with an amine group on MIL-101 (Cr)—NH₂, while the other two acid chloride groups crosslinked with the MPD monomer during interfacial polymerization, forming a robust MIL-101 (Cr)—NH₂-polyamide mixed matrix. The chemical linkage between the fillers and polyamide significantly suppressed the formation of interfacial defects. Additionally, TMC-induced in situ crosslinking of MIL-101 (Cr)—NH₂ also increased membrane hydrophilicity and modified the nanoscale structure of the polyamide phase, enhancing selectivity. On the other hand, postsynthetic modification of GPTES on MIL-101 (Cr)—NH₂ was performed to improve the particle dispersibility in hexane and stabilize the formed particle suspension during interfacial polymerization. The presence of GPTES on MIL-101 (Cr)—NH₂ minimized particle agglomerations. Correspondingly, particle loading in the polyamide thin film was increased without forming nonselective voids. The chemical grafting of GPTES and TMC molecules onto the framework narrowed the pore aperture size of MIL-101 (Cr)—NH₂ fillers (e.g., from >10 Å to ˜6 Å), which played a critical role in enhancing membrane selectivity by molecular sieving. Leveraging the merits of GPTES and TMC modifications, the resulting TFN membranes showed excellent water transport rates and rejection to both inorganic salts and small neutral contaminants. At a particle content of 0.3 wt %, the TFN membrane showed a high water permeance of 1.3 L m⁻² h⁻¹ bar⁻¹ and excellent rejection of 98.5-99.6% to NaCl, MgCl₂, Na₂SO₄, and MgSO₄ at 150 psi. Mechanistically, the high rejections related to size sieving. These conclusions were supported by evaluating rejections of the TFN membrane for small neutral contaminants. PEG200 and boric acid at a pH value of 7.5 had outstanding rejections of 99.2% and 89.0% at 150 psi, respectively. Remarkably, water permeance was about 5 times higher than that of the commercial benchmark Dow SW30XLE TFC membrane, while the rejections also outperformed the respective value obtained by the commercial benchmark at the same conditions. This Example demonstrates an effective and generalizable approach to chemically control nanoscale structures at the filler-polyamide interface, minimizing interfacial defects and simultaneously maximizing the selectivity of polyamide TFN membranes.

### Example 2

This Example describes the synthesis and characterization of an example of particles comprising a MOF comprising functional groups and their incorporation into a membrane. It has been realized that UiO-66 type MOFs, such as UiO-66-NH₂, show great potential for water separations due to their outstanding stability in aqueous environment and small triangular pore aperture size (e.g., 0.6-0.7 nm in diameter) when compared to other water-stable MOFs like MIL-101 (Cr), which allows restrictive diffusion of contaminates but sufficient water permeation. Additionally, the amine functionality of UiO-66-NH₂ can enhance hydrophilicity and offers the possibility for post-synthetic modifications. However, it has also been realized that effectively incorporating UiO-66-NH₂ nanoparticles into the polyamide thin film through interfacial polymerization without introducing defects remains a challenge for the preparation of highly selective TFN membranes.

In this Example, an effective strategy was developed to control the incorporation of UiO-66-NH₂ particles into the polyamide thin film through a postsynthetic modification approach followed by in situ chemical crosslinking between polyamide and the particles. The high reaction rate constants of amines with epoxide and aromatic acid chlorides form the basis for the modifications of UiO-66-NH₂. More specifically, (3-glycidyloxypropyl)triethoxysilane (GPTES) was chemically grafted onto UiO-66-NH₂ through an epoxide ring-opening reaction to stabilize the particle suspension of the hydrophilic UiO-66-NH₂ nanoparticles in hexane and thus suppress particle agglomeration during membrane formation. The reduced particle agglomeration also helps increase the particle content in the polyamide thin film without forming nonselective voids. In addition to GPTES modification, the UiO-66-NH₂ particles were further modified with trimesoyl chloride (TMC) to form an amide bond through a reaction of the acid chloride group from TMC with —NH₂ on UiO-66-NH₂. This reaction formed strong covalent linkages between the polyamide and the incorporated UiO-66-NH₂ fillers via an in situ chemical crosslinking of the grafted TMC with m-phenylenediamine (MPD). As a result, this approach enhances their phase compatibility and thus minimizes the formation of interfacial defects in the resulting polyamide TFN membranes. By controlling the competing reactions between GPTES and TMC with amines on UiO-66-NH₂, the approach here leverages benefits from this mixed-functionality on the MOF surface. As one additional feature, chemical grafting of GPTES and TMC onto the framework can tune the pore chemistry and pore aperture size of UiO-66-NH₂, which can further enhance its molecular sieving selectivity for water separation. The GPTES and TMC functionalized UiO-66-NH₂ nanoparticles and the fabricated TFN membranes were thoroughly characterized to reveal the structure-property relationships and to assess the feasibility and applicability of the formed TFN membranes for water separation applications.

### Experimental and Methods

All chemicals were of analytical grade and used as received without further purification if not otherwise specified. Zirconium chloride (ZrCl₄, 99.95%) purchased from STREM Chemicals and 1,4-benzenedicarboxylic acid (H₂BDC, C₆H₄ (COOH)₂, 99.0%), 2-amino-1,4-benzenedicarboxylic acid (H₂N—H₂BDC, H₂NC₆H₃-1,4-(COOH)₂, 99.0%), benzoic acid (C₆H₅COOH, ≥99.5%), acetic acid (CH₃COOH, glacial, PhEur), and anhydrous N,N-dimethylformamide (anhydrous DMF, C₃H₇NO, 99.8%) ordered from Sigma-Aldrich (USA) were used for the synthesis of MOF nanoparticles. Methanol (MeOH, CH₃OH, 99.9%) and DMF (99.8%) from VWR Chemicals were used for MOF purification. Trimesoyl chloride (TMC, C₆H₃ (COCl)₃, 98%), m-phenylenediamine (MPD, C₆H₄ (NH₂)₂, 99%), and sodium dodecyl sulfate (SDS, C₁₂H₂₅NaSO₄, >99%) supplied by Sigma-Aldrich were used as the monomers and additive for preparing the polyamide TFC and TEN membranes via interfacial polymerization. (3-Glycidyloxypropyl)triethoxysilane (GPTES, C₁₂H₂₆O₅Si, ≥97%) obtained from TCI Chemicals was used for MOF post-synthetic modification. Molecular sieves (Na₁₂ [(AlO₂)₁₂(SiO₂)₁₂]·xH₂O, 4 Å, beads, 8-12 mesh) were supplied by Sigma-Aldrich (USA), and n-hexane (C₆H₁₄, ≥99.8%, SupraSolv® for GC-MS, distilled) and toluene (C₆H₅CH₃, 99.5%) were purchased from Merck. Toluene and hexane were dried with the activated molecular sieves for several days before use. Sodium hydroxide (NaOH, 99%) ordered from Macron Fine Chemicals and deuterium oxide (D₂O, 99.9%) supplied by Cambridge Isotope Laboratories were used for preparing the NMR samples. Celite (545 Filter Aid) was purchased from Fisher Chemical for NMR sample filtration. Sodium chloride (NaCl, ≥99.5%, Sigma-Aldrich), magnesium chloride (MgCl₂, ≥99.0%, Fisher Chemical), sodium sulfate (Na₂SO₄, ≥99.0%, Acros Organics), and magnesium sulfate (MgSO₄, 99.5%, Alfa Aesar) were used as the solutes for salt rejection tests. Boric acid (H₃BO₃, 99.99%, Merck) and poly(ethylene glycol) with an M_{w} of 200 Da (PEG200, 99.9%, Sigma-Aldrich) were employed as the probe solutes for examining membrane rejections toward small neutral contaminants. The boron standard for ICP analysis (VeriSpec, 10 g/L in H₂O) was supplied by Ricca Chemical. A polyethersulfone (PES) UF membrane substrate provided by SOLETA (USA) was used as the substrate for fabricating the TFN membranes. The Dow SW30XLE membrane was used as a commercial polyamide TFC membrane benchmark for comparison. Deionized water purified by a Milli-Q ultrapure unit was provided by the Department of Chemical Engineering at the Massachusetts Institute of Technology.

UiO-66-NH₂ nanoparticles with well-controlled particle size and morphology were hydrothermally synthesized from ZrCl₄ and H₂N—H₂BDC (2-amino-1,4-benzenedicarboxylic acid) in anhydrous DMF at 120° C. for 24 h with the presence of benzoic acid and deionized water. For comparison, the parent UiO-66 particles were synthesized in DMF at 100° C. for 18 h using an acetic acid modulated solvothermal reaction of ZrCl₄ with H₂BDC (1,4-benzenedicarboxylic acid). The detailed procedure for MOF synthesis and purification is as follows:

The UiO-66-NH₂ MOF nanoparticles were synthesized in anhydrous DMF at the optimized reaction conditions. In a typical synthesis, ZrCl₄ (0.04 g, 0.172 mmol) and H₂N—H₂BDC (0.031 g, 0.172 mmol) were separately dissolved in 4 ml anhydrous DMF and then sonicated for 3 min to ensure complete dissolution. Benzoic acid (5.50 g, 45 mmol) was dissolved in 15 ml anhydrous DMF to form a 3.0 M concentrated benzoic acid solution. After that, the ZrCl₄ solution and H₂N—H₂BDC solution were mixed in a 40 ml glass vial followed by adding 1.15 ml 3.0 M benzoic acid solution and 3.1 μl deionized water. Finally, 10.85 ml DMF was added to the mixture to reach an overall volume of 20 ml. The molar equivalents of benzoic acid and water to ZrCl₄ were 20.0 and 1.0, respectively. After sonicating for 3 min to ensure complete mixing of the reaction mixture, the sealed glass vial was reacted at 120° C. for precisely 24 hours. The UiO-66 benchmark particles were synthesized by using a similar solvothermal route under different conditions. In a typical reaction, ZrCl₄ (0.04 g, 0.172 mmol) and H₂BDC (0.0284 g, 0.172 mmol) were first dissolved in 20 ml DMF in a 40 ml glass vial, and then 0.6 ml acetic acid was added into the solution. The mixture was reacted at 100° C. for 18 h in an oven after sonicating for 3 min. When the reaction was complete, yellow-white UiO-66-NH₂ and white UiO-66 particles were observed in the vial, forming a stable suspension in DMF. After naturally cooling down to room temperature, the solids were isolated by centrifugation (10,500 rpm, 15-20 min) and then washed with DMF three times followed by washing with MeOH three times. After the last washing step, the as-synthesized MOF particles were redispersed and stored in methanol at ambient conditions under shaking until further use for characterization and post-synthetic modifications.

### 2.2 Post-Synthetic Modification of UiO-66-NH₂

GPTES modification was accomplished in anhydrous toluene at 110° C. for 24 h under a nitrogen atmosphere via an epoxide ring-opening reaction between the epoxide groups and the —NH₂ functional group on UiO-66-NH₂. The molar equivalent of GPTES relative to —NH₂ of UiO-66-NH₂ was kept at 0.8. At such conditions, GPTES partially modifies the surface and some-NH₂ remains in the framework. The GPTES-modified UiO-66-NH₂ particles are denoted as GPTES@UiO-66-NH₂. Similarly, we reacted TMC with UiO-66-NH₂ in anhydrous hexane at room temperature to form an amide bond between an acid chloride and —NH₂. The molar equivalent of acid chloride to —NH₂ was kept at 1.5. The TMC-modified UiO-66-NH₂ particles are denoted as TMC@UiO-66-NH₂, while the TMC-modified GPTES@UiO-66-NH₂ particles are termed as TMC@GPTES@UiO-66-NH₂. The detailed experimental procedures for GPTES and TMC modifications are as follows:

GPTES modification on UiO-66-NH₂ particles was performed in anhydrous toluene through an epoxide ring-opening reaction with the —NH₂ group. In a typical reaction, the as-synthesized UiO-66-NH₂ suspension in methanol, containing around 0.2 g UiO-66-NH₂ particles, was solvent exchanged with toluene three times by centrifugation (10,500 rpm, 40 min). After the third centrifugation, the isolated particles were redispersed in 40 ml toluene under strong sonication. The weight/volume concentration of UiO-66-NH₂ particles in the resulting suspension was then determined by extracting a small volume (e.g., 1.0 mL) of the suspension into a preweighted glass vial, which was thoroughly dried overnight under vacuum at 130° C. The weight of the particles was obtained by reweighting the vial that contained the solid. The setup for GPTES modification reaction consisted of a 250 ml three-neck round bottom flask equipped with an air reflux condenser and a nitrogen Schlenk-line. Before adding the UiO-66-NH₂ particle suspension into the flask, the entire setup was flushed with nitrogen for 20 min and the suspension was sonicated twice using a probe sonicator each for 1 min. After that, the UiO-66-NH₂ suspension was transferred into the flask and then GPTES was added dropwise using precision pipettes under a nitrogen environment while stirring. The molar equivalent of GPTES relative to the —NH₂ groups of UiO-66-NH₂ was kept at 0.8. The corresponding equivalent of —NH₂ groups for UiO-66-NH₂ was calculated by approximating the overall stoichiometry of UiO-66-NH₂ as Zr₂₄O₁₂₀C₁₉₂H₉₆N₂₄, which corresponds to a defect-free UiO-66 MOF crystal structure. The final volume of the reaction mixture was increased to 50 ml by adding toluene. The reaction mixture was heated to 110° C. and then reacted at this temperature for 24 h with nitrogen protection under vigorous stirring (i.e., 800 rpm). When the reaction was completed, the obtained solid was washed three times with toluene following the typical centrifugation-washing cycle. The GPTES modified UiO-66-NH₂ particles are labelled as GPTES@UiO-66-NH₂.

TMC modification on UiO-66-NH₂ and GPTES@UiO-66-NH₂ was conducted in anhydrous hexane at room temperature. Before the reaction, the as-prepared particle suspension was solvent exchanged with hexane three times by using the typical centrifugation-washing procedure. After the last centrifugation, the isolated particles were redispersed in 30 ml hexane in a glass vial under strong sonication, and the particle loading was then determined by measuring the particle content in a 1.0 ml suspension, as described previously. In a typical reaction, a certain amount of TMC was added to the particle suspension and the resulting mixture was reacted at room temperature for 12 h under strong shaking. The molar equivalent of TMC to —NH₂ groups of the MOF particles was kept at 1.5. After completion of the reaction, the modified particles were collected by centrifugation and then washed with hexane three times. TMC modified UiO-66-NH₂ and GPTES@UiO-66-NH₂ particles are labelled as TMC@UiO-66-NH₂ and TMC@GPTES@UiO-66-NH₂, respectively.

The polyamide TFN membranes were prepared via an interfacial polymerization of TMC and MPD on a PES UF membrane substrate. The MOF nanoparticles were dispersed in the TMC/hexane monomer solution and the particle loading varied from 0.04% to 0.3 wt % while the concentration of TMC monomer was kept constant at 0.15 wt %. TFN membranes were made from TMC@GPTES@UiO-66-NH₂ and the parent UiO-66 particles, and these samples are labeled as TFNg(X) and TFN(X), respectively, where X represents the particle loading in hexane. The TFC control membrane was fabricated for comparison using the same procedure without adding any particles. All the prepared membranes were stored in deionized water at 5° C. for further characterization and performance tests. The specific reaction parameters and the detailed experimental procedures for interfacial polymerization are presented as follows:

The polyamide TFN membranes were prepared via an interfacial polymerization reaction of TMC and MPD on a PES UF membrane substrate. Homogeneous suspensions of MOF particles with different particle loadings in anhydrous hexane were prepared with the aid of ultrasonication. TMC monomer was then dissolved in each suspension right before interfacial polymerization. In this work, the particle loadings in TMC/hexane monomer solution varied from 0.04-0.3 wt % while the concentration of TMC was kept constant at 0.15 wt % for each loading. In a typical procedure, the PES substrate was firstly immersed in an aqueous solution containing 2.0 wt % MPD and 0.1 wt % SDS for 2 min. After removing the excess water solution on top using filter papers, the MPD saturated PES substrate was sandwiched into a lab-made frame with the top surface facing upward to the opening. Interfacial polymerization was completed by carefully adding the 0.15 wt % TMC hexane solution with varying particles concentrations into the frame. After reacting for 1 min at room temperature, the excessive hexane solution was removed and the resulting membrane was dried in air at ambient conditions for 2 h. TFN membranes made from TMC@GPTES@UiO-66-NH₂ and UiO-66 particles are denoted as TFNg(X) and TFN(X), respectively, where X represents the particle loading in the hexane pre-reactant suspension by weight. The TFC benchmark membrane was also fabricated for comparison using the same procedure without adding any MOF particles. All the prepared membranes were stored in deionized water at 5° C. for further characterization and performance tests.

Powder X-ray diffraction (XRD) measurements were performed on a Rigaku Smartlab Multipurpose Diffractometer equipped with a Cu tube (2-1.5406 Å) and a VANTEC-500 2D detector at a voltage of 45 kV and 200 mA. XRD patterns were measured at ambient conditions over an angular range of 5-50° (2θ) with a step size of 0.1°. Fourier-transform infrared (FT-IR) spectra were acquired on an Alpha II Fourier transform infrared spectrometer (FT-IR 6700, Bruker) in the attenuated total reflection (ATR) mode. Each sample was measured for a total of 32 scans with a resolution of 4 cm⁻¹ in a spectral range of 400-4000 cm⁻¹. X-ray photoelectron spectroscopy (XPS) analysis was conducted on a ULVAC-PHI Versaprobe II instrument with a monochromic Al-Kα X-ray source (hv=1486.6 eV). The X-ray source power was 50 W and the beam spot size was 200 μm. Transmission electron microscope (TEM) images were collected on an FEI Tecnai (G2 Spirit TWIN) multipurpose digital system that was operated at 120 kV. The TEM sample was typically prepared by casting a few drops of the diluted MOF suspension in MeOH on a lacey carbon-coated 200 mesh copper grid (Electron Microscopy Sciences) and then the grid was allowed to dry at room temperature to ensure complete evaporation of the solvent. A Zeiss Merlin high-resolution scanning electron microscope (SEM) was used for particle and membrane morphological analysis. SEM samples were thoroughly dried under vacuum and then sputter-coated with gold using a Desk II cold sputter unit (Denton Vacuum LLC). Thermogravimetric analysis (TGA) was performed on a TA Instruments 550 thermogravimetric analyzer under temperature ramp mode. In a typical measurement, the sample was first heated to 100° C. with a heating rate of 10° C./min followed by a constant temperature interval for 1 h under N₂ to remove the moisture. After that, the temperature was allowed to equilibrate to 40° C., then the gas was switched to air and the sample was heated to 1000° C. at 10° C./min. Water contact angles were collected on a Contact Angle Geniometer (Rame Hart, USA) using deionized water as the probe liquid. Powder samples were pressed into tablets by using a press machine and the membrane samples were freeze-dried overnight right before the measurements. The surface zeta potential of the MOF nanoparticles at a pH value of 7.5 was measured by using a NanoBrook Series zeta potential analyzer (Brookhaven Instruments) at 23° C. The particles were dispersed in deionized water at a low sample loading and the particle suspension was sonicated for 5 min right before the measurements. The N₂ adsorption-desorption isotherms were recorded through a Micromeritics 3Flex apparatus at 77 K. Before the measurements, 150-200 mg of MOF particles were vacuum dried at 130° C. overnight and then loaded into a glass analysis tube, which was then heated and evacuated on a degas port. The degassing process included an initial ramp to 100° C. at 10° C./min, an isothermal interval at 100° C. for 30 min, and an increase in temperature to 130° C. at 10° C./min where the temperature was kept constant for 12 h. When degassing was completed, the sample was naturally cooled down to room temperature and nitrogen was backfilled into the analysis tube before it was transferred to the analysis port to collect the adsorption-desorption isotherms. Proton nuclear magnetic resonance (1H-NMR) spectroscopy was obtained using an Ascend 500 spectrometer (Bruker with TopSpin 3.2) at 500 MHz. Typically, 15-20 mg MOF particles were digested in 2 ml of 1 M NaOH solution in D₂O for one day, and the resulting suspension was then filtered through Celite to remove any residual solids.

### 2.5 Membrane Performance Tests

The water separation performances of the TFC and TEN membranes were evaluated in RO mode using a Sterlitech HP4750 high-pressure stirred cell with an effective membrane area of 14.6 cm². The membrane sample was first held at 150 psi for at least 2 h and then pure water flux (J_{w}, L m⁻² h⁻¹) was measured at different pressures using deionized water as the feed. Membrane rejection tests were then performed using inorganic salts (i.e., NaCl, MgCl₂, Na₂SO₄, and MgSO₄) and small neutral molecules (i.e., PEG200 and boric acid) as the solutes under various testing conditions. The pure water permeance (A, L m⁻² h⁻¹ bar⁻¹), solute rejection (R, %), solute permeability coefficient (B, L m⁻² h⁻¹), and the water/solute selectivity (A/B, bar⁻¹) were reported. A long-term performance stability test for 480 h was conducted at 150 psi using 2000 ppm NaCl solution as the feed. The detailed testing conditions and parameters are provided as follows:

Water separation performance of the TFC and TEN membranes was evaluated using a Sterlitech HP4750 high-pressure stirred cell under different testing conditions. The cell is designed to house a circular membrane coupon with an effective membrane area of 14.6 cm². A magnetic stirring rod was placed in the cell on top of the membrane to minimize external concentration polarization during tests. Before collecting data, the membrane sample was pressurized and washed with deionized water at 150 psi for at least 2 h. After holding for this time, pure water flux (J_{w}, L m⁻² h⁻¹) was measured at different pressures using deionized water as the feed, and water permeance (A, L m⁻² h⁻¹ bar⁻¹) was then calculated as

$$A = \frac{{J}_{w}}{Δ P} = \frac{Δ V}{S Δ t Δ P} \qquad ( 1 )$$

where ΔP (bar) is the trans-membrane hydraulic pressure, S (m²) is the effective membrane surface area, and ΔV (L) is the volume of permeate collected over a time interval of Δt (h).

Membrane rejection tests were then performed under various testing conditions using different types of solutes. Solutions containing different amounts of NaCl, Na₂SO₄, MgCl₂, and MgSO₄ were used as the feed to examine the membrane rejection to inorganic salts, while the 200 ppm PEG200 solution and 5 ppm boric acid solution at a pH value of 7.5 were used as the probes to determine membrane rejection towards small natural contaminants. The membrane rejection R (%) was calculated as

$$R ( \% ) = ( 1 - \frac{{C}_{p}}{{C}_{f}} ) \times 100 \qquad ( 2 )$$

where Cₚ and C_{f} are the solute concentrations of the permeate and feed at steady-state conditions. The salt concentrations in the permeate and feed were determined by conductivity measurements using a SevenCompact™ S230 (Mettler Toledo) conductivity meter. The PEG200 and boric acid contents were measured by a Total Carbon Analyzer (TOC, Multi N/C 3100, Analytik Jena, Germany) and Inductively Coupled Plasma-Optical Emission Spectrometer (ICP-OES, Agilent ICP-OES 5100 VDV), respectively. The solute permeability coefficient (B, L m⁻² h⁻¹) was then estimated by the following equation:

$$B = ( \frac{100 \%}{R} - 1 ) \times {J}_{w} \qquad ( 3 )$$

### Results and Discussion

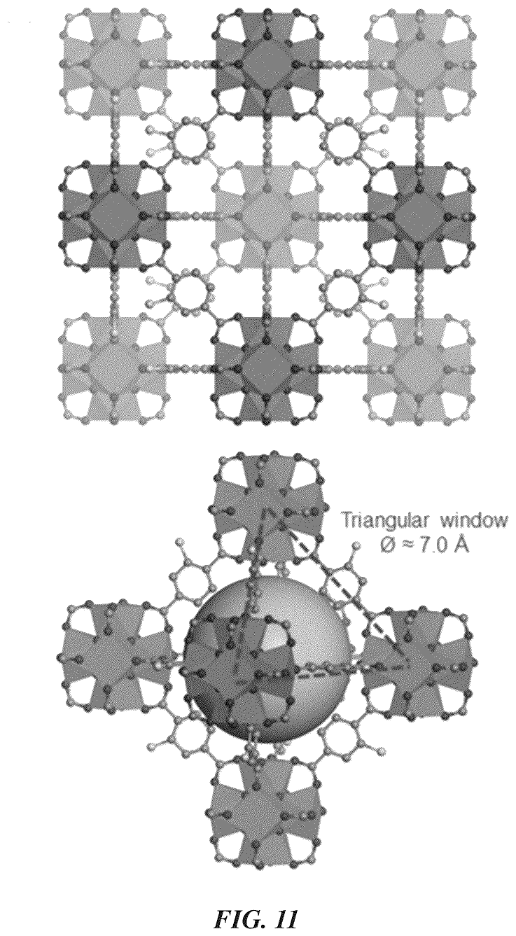

UiO-66-NH₂ nanoparticles with well-controlled particle size and morphology were directly synthesized from the H₂N—H₂BDC ligand via a hydrothermal reaction under optimized conditions. SEM and TEM images showed that the as-synthesized UiO-66-NH₂ particles had a small size of less than 100 nm in diameter, there were limited particle aggregates formed, and the individual particles had a shape that is roughly spherical. It was believed in the context of this disclosure that the small particle size and limited aggregation would be favorable for the formation of defect-free polyamide-filler composites even at high filler loadings as the small nanoparticles can be properly accommodated within the polyamide thin layer. The parent UiO-66 particles with a particle size of less than ˜120 nm in diameter were also synthesized as the benchmark for comparison. FIG. 11 shows the crystalline structures of the UiO-66-NH₂ MOF nanoparticles. The sphere indicates accessible pore volume.

Powder XRD patterns confirmed that the UiO-66-NH₂ and UiO-66 particles had essentially identical Bragg diffraction angles as those of the theoretically simulated UiO-66 MOF crystals, with pronounced peaks at 7.5° and 8.5° associated with the and crystal planes. The high peak intensity indicates their crystalline nature while the relatively broad diffraction peaks suggest their small particle size. The chemical identities of UiO-66-NH₂ were confirmed from the FT-IR spectra, and the N 1s peak centered at 399.2 eV in the XPS spectra. The IR peaks at 3490 cm⁻¹ and 3365 cm⁻¹ are ascribed to the —N—H asymmetric and symmetric vibrations while the signals at 1625 cm⁻¹ and 1338 cm⁻¹ are attributed to the —N—H bending vibration and the —C—NH₂ stretching of the phenyl ring, respectively. The parent UiO-66 benchmark showed almost the same chemical structure except for those features that originated from the —NH₂ groups.

TGA data demonstrated the excellent thermal stability of the UiO-66-NH₂ and UiO-66 particles, where a first small weight loss at temperatures below 350° C. could be ascribed to the removal of a trace amount of the embedded hydroxyl and modulators, while a second weight loss at temperatures up to 650° C. indicated the loss of the linkers. A final mass at 800° C. corresponds to ZrO₂. Due to the presence of —NH₂ groups, a larger total weight loss was observed by UiO-66-NH₂ at high temperatures compared to the UiO-66 benchmark. N₂ adsorption-desorption isotherms of the two MOFs at 77 K were acquired. Since they have an isostructural topology, UiO-66-NH₂ and UiO-66 showed the same type of isotherms while the former had slightly higher surface areas than the latter (i.e., 1150 vs. 1050 m² g⁻¹ for BET surface area and 1460 vs. 1390 m² g⁻¹ for Langmuir surface area) with a similar pore volume of about 0.43 cm³ g⁻¹ (Table 4). The obtained pore size distribution curves in showed that the pore diameters of both MOFs lie in the range of 5-10 Å and the averaged pore diameter is around 6.0-7.0 Å, which is consistent with their crystalline structures. The distribution of larger pores between approximately 13 and 18 Å that were observed in UiO-66 was likely a result of some concentration of missing linker defects, which is often observed when using modulators such as acetic acid during synthesis. In addition, both MOFs showed relatively high positive zeta potential values in water at a pH value of 7.5 (Table 4), suggesting their positively charged surfaces and hydrophilicity. The higher zeta potential for UiO-66-NH₂ than that of UiO-66 further supports the presence of —NH₂ groups.

TABLE 4
Summary of the physicochemical properties of UiO-66, UiO-66-NH₂,
GPTES@UiO-66-NH₂, and TMC@UiO-66-NH₂ nanoparticles.

| | BET | Langmuir | t-plot | | |
|---|---|---|---|---|---|
| | surface | surface | micropore | Particle | |
| Sample | area | area | volume | size | ζ |
| name | (m² g⁻¹)^{a} | (m² g⁻¹)^{a} | (cm³ g⁻¹) | (nm)^{b} | (mV)^{c} |
| UiO-66 | 1050 | 1390 | 0.428 | <120 | 11.4 |
| UiO-66-NH₂ | 1150 | 1460 | 0.432 | <100 | 20.1 |
| GPTES@UiO- | 780 | 890 | 0.252 | <100 | 2.1 |
| 66-NH₂ | | | | | |
| TMC@UiO- | 630 | 810 | 0.221 | <100 | −16.5 |
| 66-NH₂ | | | | | |

^{a}Specific surface area was calculated in the P/P₀ range of 0.05-0.2,
^{b}particle size was obtained from TEM images, and
^{c}Zeta potential was measured in water at a pH value of 7.5.

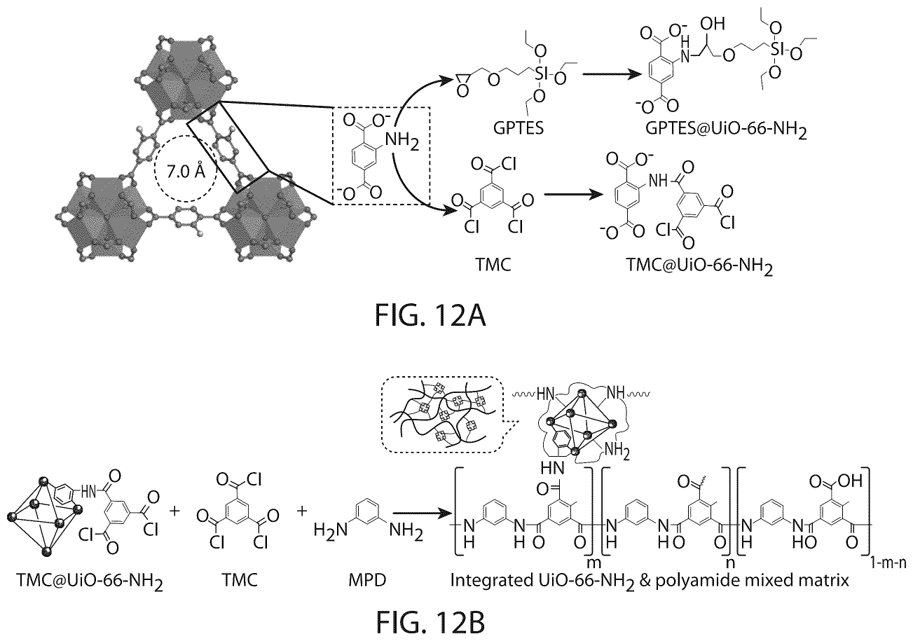

When considering the limited thickness of the polyamide selective layer, a small particle size of UiO-66-NH₂ nanoparticles can be preferable in some embodiments for making effective TFN membranes. However, the small size and high surface area of the hydrophilic UiO-66-NH₂ particles make them highly susceptible to agglomeration in hexane during interfacial polymerization. The large aggregates are prone to voids between particles in the polyamide thin film, resulting in non-selective diffusion for various species and analytes of interest even at low particle loadings. To address this challenge, GPTES post-synthetic modification was used to lower the attraction between particles by improving the compatibility between UiO-66-NH₂ nanoparticles and hexane. As depicted in FIG. 12A the modification was performed by the nucleophilic attack of the —NH₂ moiety on UiO-66-NH₂ with the epoxide group of GPTES via a ring-opening reaction. The high affinity of the grafted GPTES molecules with hexane could stabilize the formed particle suspension in the TMC monomer solution and suppress particle agglomeration during membrane formation.

Powder XRD patterns in and TEM images in showed that GPTES modification had negligible influences on MOF crystallinity, particle size, and morphology because of the robust chemical stability of UiO-66-NH₂ under the reaction conditions considered. The successful grafting of GPTES was confirmed by the FT-IR and XPS spectra. GPTES@UiO-66-NH₂ particles showed a characteristic vibration peak of Si—O at 1000 cm⁻¹, while a broad peak at 2900-3000 cm⁻¹ was attributed to the vibration of the C—H bonds on GPTES. The appearance of Si signals in the XPS spectra further confirmed the presence of GPTES on GPTES@UiO-66-NH₂. The grafted GPTES molecules caused significantly larger weight losses in GPTES@UiO-66-NH₂ at temperatures ≤350° C. and temperatures ≥800° C. compared to the pristine UiO-66-NH₂.

The ¹H-NMR spectra of the digested GPTES@UiO-66-NH₂ particles clearly showed the signals for the hydrogen nuclei of GPTES, further confirming the incorporation of GPTES during the modification step. Integration of the peaks attributed to H₂N—H₂BDC and GPTES resulted in a calculation of a 14.0% conversion rate of the total-NH₂ groups in UiO-66-NH₂ for the modification reaction. Due to the presence of GPTES on the framework surface, a significant drop in zeta potential from 20.1 to 2.1 mV (Table 4) was also observed for the GPTES@UiO-66-NH₂ particles. Consistent with our hypothesis and the characterization above, the GPTES@UiO-66-NH₂ nanoparticles were observed to have significantly improved dispersibility in hexane. In contrast, the pristine UiO-66-NH₂ particles aggregated and precipitated quickly. Interestingly, it was also found that GPTES modification had an effect on the pore aperture of UiO-66-NH₂. As displayed in Table 4, the BET surface area of GPTES@UiO-66-NH₂ decreased from 1150 to 780 m² g⁻¹ with a concomitant reduction in pore aperture size and pore volume. According to TGA data in, this drop in BEST surface area is much larger than that caused by the formation of a dense GPTES shell on the surface of the MOF particles, suggesting that partial pore blockage by the penetration of GPTES occurred during modification. The reduced pore aperture size would further improve the molecular sieving ability of the UiO-66-NH₂ particles.

Another challenge that generally exists in the fabrication of polyamide TFN membranes is the formation of defects at the interface of polyamide and the fillers, which could deteriorate membrane selectivity. To address this challenge, in situ chemical crosslinking between polyamide and the UiO-66-NH₂ fillers was employed to improve the compatibility of the two components. As illustrated in FIG. 12A, TMC was chemically anchored onto UiO-66-NH₂ by forming an amide bond between acid chloride functionality and the —NH₂ moiety. During interfacial polymerization, the unreacted acid chlorides on the grafted TMC remain accessible for subsequent crosslinking reactions with MPD, resulting in strong chemical linkages between the two components (FIG. 12B), which suppressed the formation of interfacial defects. Powder XRD patterns suggested that the crystallinity of the UiO-66-NH₂ particles was preserved during TMC modification. A sharp absorbance peak at 1680 cm⁻¹ owing to the stretch of the C═O bond and a broad peak around 2900 cm⁻¹ due to the vibration of the C—H bonds on the benzene ring of TMC emerged in the FT-IR spectra as well as the appearance of a chlorine peak in the XPS spectra of the TMC@UiO-66-NH₂ particles, confirming the successful grafting of TMC onto UiO-66-NH₂. The grafted TMC molecules lead to larger weight losses in the TGA curve of TMC@UiO-66-NH₂ compared to the pristine UiO-66-NH₂. The 1H-NMR spectra of the digested TMC@UiO-66-NH₂ showed trimesic acid residues that were formed by the hydrolysis of the grafted TMC during digestion. Through 1H-NMR, a conversion of 12.0% was obtained for the —NH₂ groups reacting with TMC, which closely matches values estimated from the TGA (i.e., 12.4%). Similar to GPTES modification, it was observed that TMC modification resulted in a decrease in surface area, pore aperture size, and pore volume. Since TMC is smaller than GPTES and has a higher reactivity with —NH₂, TMC modifications provide a more effective way, in at least some embodiments, to finely tune the pore aperture size and chemistry of UiO-66-NH₂. A significant decrease in zeta potential, from 20.1 mV to −16.5 mV (Table 4), was also observed for the TMC@UiO-66-NH₂ particles, which is believed to originate from the formation of a large number of carboxylic acid groups in the framework upon the hydrolysis of the incorporated TMC. When applying both GPTES and TMC modifications, the resulting TMC@GPTES@UiO-66-NH₂ particles showed a notable decrease in pore size with a narrower pore size distribution curve. It is important to note that the achieved pore size of ˜6.0 Å is larger than that of H₂O (˜2.8 Å) but smaller than the sizes of many hydrated ions such as Na⁺ (7.16 Å), Cl⁻ (6.64 Å), and Mg²⁺ (8.8 Å) (Table 5). In the context of water separations, the small pore size and hydrophilic nanochannels with negative charges in the TMC@GPTES@UiO-66-NH₂ fillers constrict pores to dimensions more favorable for size sieving, as will be investigated later.

TABLE 5
The ionic radii, hydrated ionic radii, and Gibbs free energies
of hydration for ions typically found in brine water.

| | | | Gibbs free |
|---|---|---|---|
| | Ionic | Hydrated | energy of |
| | radius | radius | hydration |
| Ion | (Å) | (Å) | (kJ mol⁻¹) |
| Na⁺ | 0.95 | 3.58 | −365 |
| Mg²⁺ | 0.65 | 4.4 | −1830 |
| Ca²⁺ | 0.99 | 4.2 | −1505 |
| Li⁺ | 0.69 | 3.82 | −475 |
| Cl⁻ | 1.81 | 3.32 | −340 |
| SO₄²⁻ | 2.30 | 3.79 | −1080 |
| HCO₃⁻ | 1.56 | 4.39 | −335 |
| NO₃⁻ | 1.79 | 3.40 | −300 |

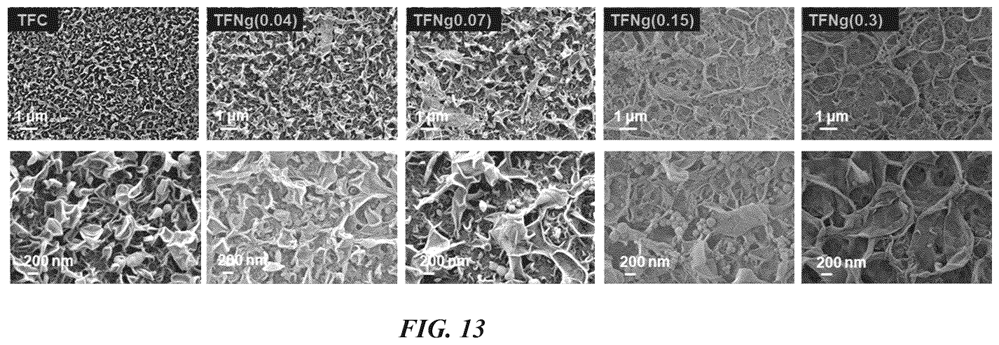

The TFC benchmark and TFN membranes with different TMC@GPTES@UiO-66-NH₂ particle loadings were then fabricated via interfacial polymerization on a PES substrate. The PES substrate had a porous cross-section structure with a smooth top surface. It can withstand high pressures up to 150 psi and shows high water permeance greater than 110 L m⁻² h⁻¹ bar⁻¹ with negligible rejections to NaCl. SEM images in FIG. 13 confirmed that a continuous polyamide thin film with the typical “ridge-and-valley” surface morphology was successfully formed with the presence of MOF particles. However, the incorporation of the TMC@GPTES@UiO-66-NH₂ particles led to a visible increase in the size of the “ridge” structure of the polyamide, and this morphology becomes more pronounced as the particle loading rises (FIG. 13). This observation suggests that the particles influence the formation of the polyamide during interfacial polymerization possibly through the in situ crosslinking and altered diffusion of the MPD monomers.

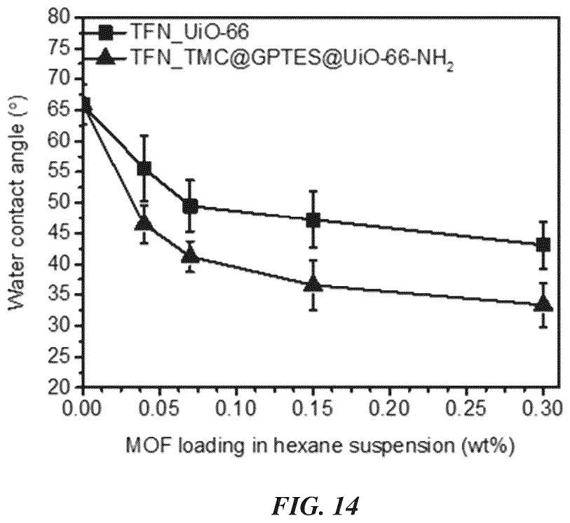

In addition to the direct observation from the SEM images, the Zr signal was observed in the XPS measurements of the TFNg membranes, confirming the successful incorporation of the MOF particles. It was further observed that the MOF content in the TFN membranes significantly increased with increasing particle loading in the hexane suspension. From these results, the TFNg membranes clearly had higher particle content than the TFN control membranes prepared with the UiO-66 benchmark. This feature demonstrates that GPTES modification and TMC-induced in situ crosslinking effectively promote the incorporation of the particles into the polyamide thin film. Interestingly, the presence of TMC@GPTES@UiO-66-NH₂ particles during interfacial polymerization also alters the crosslinking degree of the polyamide phase. It was observed that both TFNg membranes and the TFN benchmark membranes showed a monotonic increase in O/N atomic ratio with increasing MOF loading. This finding results from the higher oxygen content in the carboxylate UiO-66 MOF relative to that of the polyamide. However, the TFNg membranes displayed lower overall O/N ratios than the TFN benchmark at relatively low particle loadings even though the former has higher MOF content, implying that the cross-linking degree of the polyamide was increased by the TMC@GPTES@UiO-66-NH₂ particles. The MOF nanoparticles are likely to interfere with the interfacial polymerization of monomers by accelerating the diffusion of the MPD monomer and removal of the formed HCl byproduct via MOF adsorption. Water contact angles presented in FIG. 14 indicated that the incorporation of the hydrophilic MOF particles dramatically improves membrane hydrophilicity.

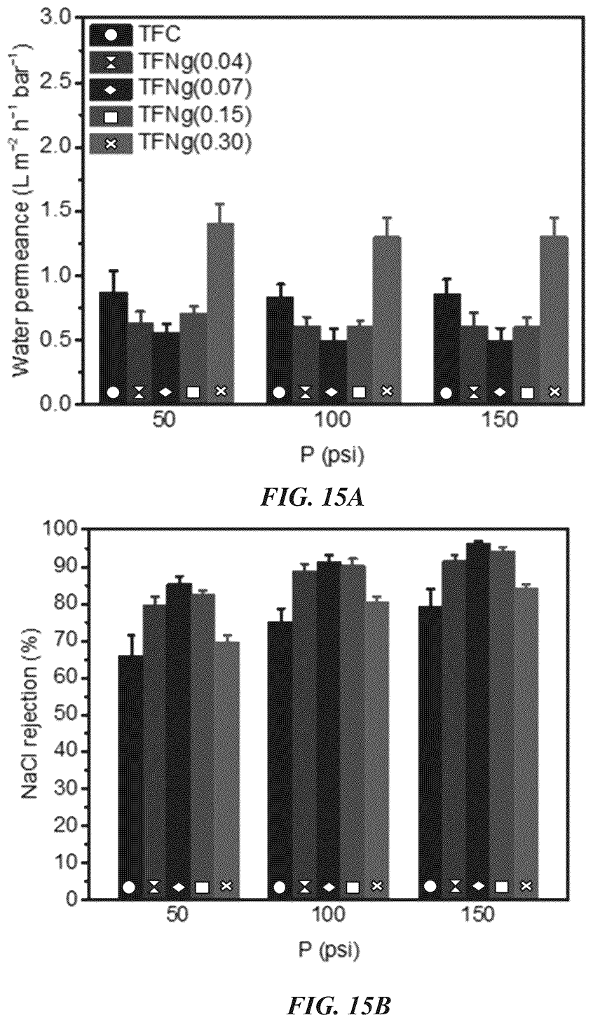

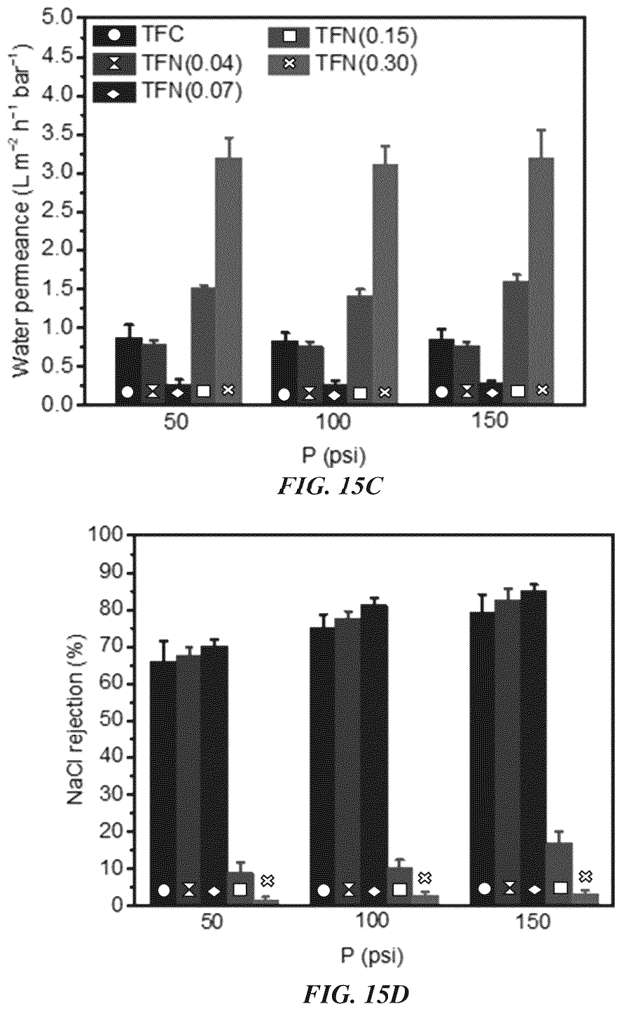

In terms of water permeance and rejection, the water separation performance of the TFNg membranes was examined using NaCl as the solute. As presented in FIG. 15A, the TFC control membrane showed a water permeance of ˜0.85 L m⁻² h⁻¹ bar⁻¹, and the incorporation of the MOF particles resulted in a slight decline in pure water permeance, where the water permeance of the TFNg (0.04), TFNg (0.07), and TFNg (0.15) membranes decrease to 0.65, 0.55, and 0.7 L m⁻² h⁻¹ bar⁻¹, respectively. The decrease in water permeance can be ascribed to the small pore size of the MOF fillers and the changes in surface morphology and crosslinking degree of the polyamide layer, which result in a reduction in water transport rate by creating a denser polyamide layer with less effective surface area. In contrast, as shown in FIG. 15B, a substantial increase in NaCl rejections at all testing pressures was achieved with the TFNg membranes, suggesting a defect-free structure of the formed polyamide-filler composite within the resolution of these experiments. For example, the NaCl rejection of the TFNg (0.04), TFNg (0.07), and TFNg (0.15) membranes at 150 psi was significantly increased from 79.3% for the TFC to 92.0%, 97.0%, and 94.2%, respectively. To the best of our knowledge, these results are quite different from those of the reported polyamide TFN membranes, where the incorporation of the filler particles into the polyamide layer is generally prone to a negligible change in rejection, and typically, a decrease in selectivity when compared to the respective TFC benchmark. The increases in NaCl rejection for the TFNg membranes were in good qualitative agreement with the small pore size of the TMC@GPTES@UiO-66-NH₂ fillers improving molecular sieving ability in the TFN membranes. At the same time, the improved interfacial compatibility enhanced the selective transport of species across the membrane. When a further increase in the particle loading to 0.3 wt % was considered, defects were observed in the resulting TFNg (0.3) membrane and the NaCl rejection decreased to 84.2% at 150 psi with a concomitant increase in water permeance (i.e., 1.4 L m⁻² h⁻¹ bar⁻¹). Of note, however, at such high particle loading, the TEN membrane rejection still outperformed the TFC control membrane and the water permeance is almost doubled. FIGS. 15C-15D show that the TFN membranes prepared with the UiO-66 benchmark particles had a similar trend in water permeance but a significantly different trend in NaCl rejections, where the incorporation of the UiO-66 particles at relatively low loadings shows little impact on membrane rejection to NaCl. When the particle loading increases to 0.15 wt % and 0.3 wt %, the NaCl rejection of the TEN membranes decreased to 17.0% and 3.5% at 150 psi, respectively. Such results confirm our hypotheses that GPTES modification can significantly suppress particle-agglomeration-induced nonselective voids and that TMC-induced in situ crosslinking can effectively reduce interfacial defects even at relatively high particle loadings.

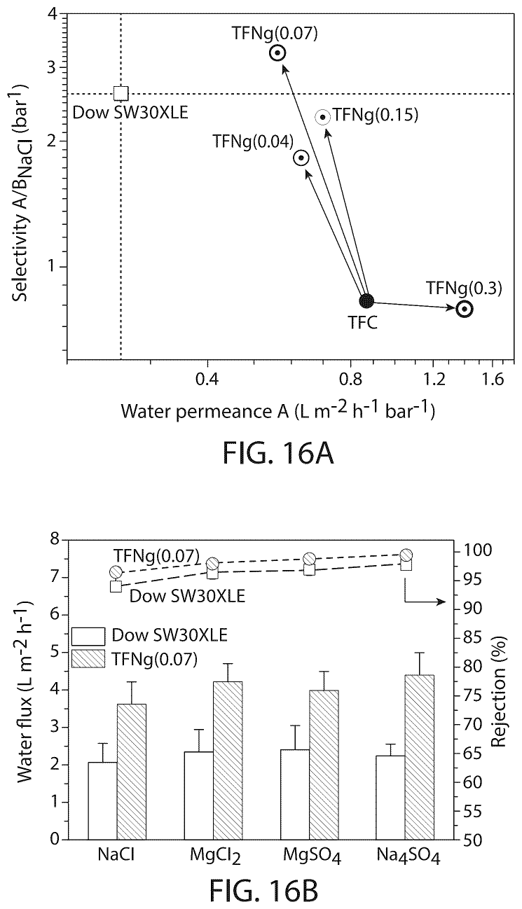

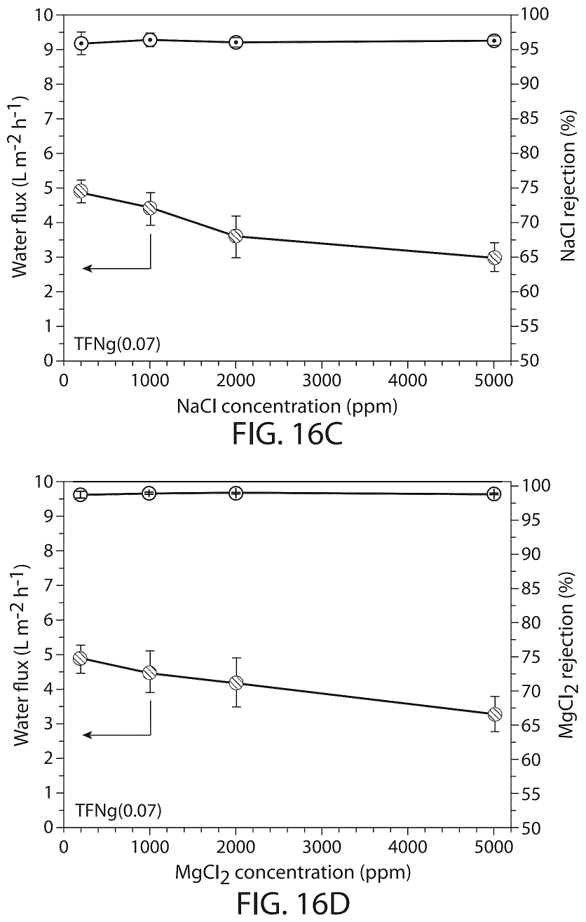

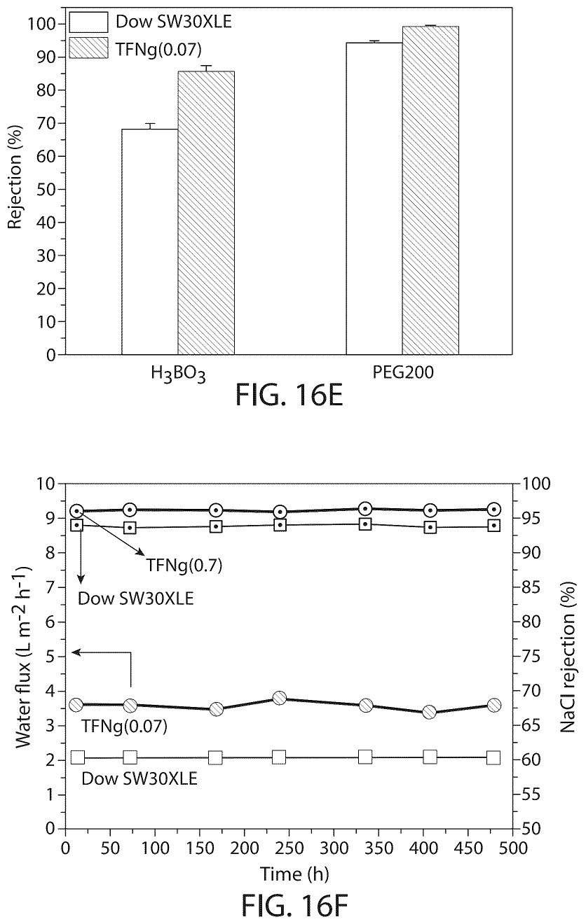

When compared to one TFC commercial benchmark, FIG. 16A shows that the TFNg (0.07) membrane had a two-fold increase in water permeance and a higher water/NaCl selectivity while the TFNg (0.04) and TFNg (0.15) membranes have similar water/NaCl selectivity with a more than doubled water permeance. In addition to NaCl, the TFNg (0.07) membrane showed exceptional rejections to MgCl₂ (98.0%), MgSO₄ (99.0%), and Na₂SO₄ (99.2%) with a high water flux of greater than 4.0 L m⁻² h⁻¹ at 150 psi (FIG. 16B). The combined rejections for each salt and water flux are higher than those of the commercial benchmark, suggesting that this approach may find use in developing TFNg membranes for desalination or other salt removal applications. To investigate a range of salt concentrations for various water purification applications, FIG. 16C and FIG. 16D further demonstrated that the high rejections to NaCl and MgCl₂ were sustained at a wide range of solute concentrations from 200 to 5000 ppm. In addition to inorganic salts, the TFNg membranes displayed efficient rejections toward small neutral contaminants as well. As depicted in FIG. 16E, the TFNg (0.07) membrane showed high rejections of 99.0% and 86.0% at 150 psi to PEG200 and boric acid, respectively, at a pH of 7.5. Conversely, the SW30XLE benchmark exhibited a lower rejection of 94.0% and 69.0% to PEG200 and boric acid under the same testing conditions. Long-term performance tests in FIG. 16F confirmed the good structural stability of the TFN membranes. The high rejections to both inorganic salts and small neutral contaminants by the TFNg membranes demonstrated the potential of the reported post-synthetic modifications and in situ crosslinking strategies for addressing defects in polyamide TFN membranes and improving selectivity.

### Conclusion

Highly selective polyamide TFN membranes were developed through effective control of the chemistry at the polyamide-filler interface and the polyamide nanostructure by using a rational post-synthetic modification and in situ cross-linking strategy. Specifically, GPTES modification was performed on UiO-66-NH₂ MOF nanoparticles via an epoxide ring-opening reaction. As a result of the high affinity of GPTES with hexane, the GPTES-modified UiO-66-NH₂ nanoparticles show significantly improved dispersion stability in the TMC/hexane solution during interfacial polymerization, thereby suppressing the formation of particle agglomerations and nonselective voids in the polyamide thin layer. Additionally, TMC was chemically grafted onto the UiO-66-NH₂ nanoparticles through the formation of an amide linkage between an acid chloride of TMC and the amine on UiO-66-NH₂. During interfacial polymerization, unreacted acid chloride groups on the grafted TMC moiety crosslinked with MPD to form a uniform MOF/polyamide mixed matrix with covalent bonds between the two phases. This in situ crosslinking significantly enhanced the compatibility of two components, reducing the formation of interfacial defects. In addition, the chemical grafting of GPTES and TMC molecules onto UiO-66-NH₂ introduced negatively charged groups and reduced the pore aperture size of the MOF framework, improving membrane selectivity for both ions and uncharged species. Thus, these synergistic design features resulted in excellent rejections to both inorganic salts and small neutral contaminants with simultaneously enhanced water flux rivaling the commercial TFC benchmark membrane. The TFN membrane with an improved particle loading showed high rejections of 97.0-99.2% to NaCl, MgCl₂, Na₂SO₄, and MgSO₄ with a water flux greater than 4.0 L m⁻² h⁻¹ at 150 psi. Excellent rejections toward small neutral contaminants such as PEG200 (i.e., 99.0%) and boric acid (i.e., 86.0%) at a pH of 7.5 were also achieved by the TEN membranes. This Example represents an important advancement in the fabrication of selective polyamide TFN membranes through manipulating the interfacial chemistry and nanostructure of the polyamide-filler composite.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A membrane, comprising:
a polymer matrix; and
particles, at least some of which reside within the polymer matrix, the particles comprising a metal-organic framework comprising functional groups, wherein:
a first plurality of the functional groups are bonded to a hydrophobic species; and
a second plurality of the functional groups are bonded to a crosslinking agent bound to the polymer matrix.

2. The membrane of claim 1, wherein the first plurality of the functional groups and/or the second plurality of the functional groups are located on an external surface of the particles.

3. The membrane of claim 1, wherein a third plurality of the functional groups are located in one or more channels of the metal-organic framework and are free hydrophilic functional groups.

4. The membrane of claim 1, wherein the hydrophobic species comprises a silicon-containing species.

5. The membrane of claim 1, wherein the hydrophobic species is (3-glycidyloxypropyl)triethoxysilane (GPTES).

6. The membrane of claim 1, wherein the crosslinking agent comprises or is a reaction product of an organic linker comprising two or more acid halide groups.

7. The membrane of claim 1, wherein the crosslinking agent comprises or is a reaction product of a trimesoyl halide.

8. The membrane of claim 1, wherein the polymer matrix comprises a polyamide.

9. The membrane of claim 1, wherein at least some of the functional groups are hydrophilic functional groups.

10. The membrane of claim 1, wherein the functional groups comprise amino groups.

11. The membrane of claim 1, comprising a layer comprising the polymer matrix.

12. The membrane of claim 11, wherein the layer has an average thickness of less than or equal to 250 nm.

13. The membrane of claim 11, wherein the layer is a first layer, and the membrane further comprises a porous support layer adjacent to the first layer.

14. The membrane of claim 1, wherein the particles have an average largest cross-sectional dimension of less than or equal to 150 nm.

15. The membrane of claim 1, wherein the metal-organic framework comprises MIL-101 (Cr) functionalized with the functional groups and/or UiO-66 functionalized with the functional groups.

16. A method for forming at least a portion of a membrane, comprising:
providing particles comprising a metal-organic framework in a solution comprising a crosslinking agent, wherein the metal-organic framework comprises functional groups; and
exposing the particles and the crosslinking agent from the solution to a polymer or a monomer thereof such that at least some of the particles become crosslinked to a matrix of the polymer via a reaction between (a) a crosslinking agent that is or becomes bonded to a plurality of the functional groups and (b) the polymer or a monomer thereof.

17. The method of claim 16, wherein the providing the particles in the solution comprises suspending the particles in the solution.

18. The method of claim 16, wherein at least some of the plurality of functional groups are bonded to the crosslinking agent prior the exposing step.

19. The method of claim 16, wherein the plurality of the functional groups is a first plurality, and a second plurality of the functional groups are bonded to a hydrophobic species.

20.-31. (canceled)

32. A thin film nanocomposite membrane comprising amine-functionalized metal organic framework (MOF) nanoparticles attached to a polyamide thin-film composite (TFC) membrane.

33.-57. (canceled)
